(19) United States
(12) Patent Application Publication
(10) Pub. No.: US 2002/0194421 A1
(43) Pub. Date: Dec. 19, 2002

(54) Computer system with multiple heaps and heap reset facility

(75) Inventors: Robert Francis Berry, Austin, TX (US); Edward John Slattery, Winchester (GB); Matthew Alexander Webster, Hook (GB)

Correspondence Address: Gregory M. Doudnikoff, IBM Corp, IP Law Dept T81/503, 3039 Cornwallis Road, PO Box 12195, Research Triangle Park, NC, 27709-2195, US

(73) Assignee: International Business Machines Corporation, Armonk, NY

(21) Appl. No.: 10/095,896

(22) Filed: Mar. 12, 2002

(30) Foreign Application Priority Data
Mar. 30, 2001 (GB) 0107921.9

(51) Int. Cl. G06F 12/00; G06F 9/44

(52) U.S. Cl. 711/100

(57) ABSTRACT

A computer system is used to run one or more programs. It includes a memory having at least a first heap and a second heap in which objects are stored, with a first object being stored on the first heap. A write barrier is provided for detecting that said the first object has been updated by a program to include a first reference to a memory location in the second heap. The write barrier outputs a cross-heap event specifying information about the first reference and the current state of said program. The system further includes a reset facility for the second heap whereby all objects stored within the second heap are deleted. As part of the reset, if a reference from the first heap to the second heap is detected, a reset event is fired specifying information about the second reference. The information in the reset event can be combined with the information in the cross-heap event to determine if the first reference matches the second reference.

### RELATED CASES

This case is related to commonly assigned U.S. patent application Ser. No. ______ filed on ______ (IBM docket number GB92000101US1).

### FIELD OF THE INVENTION

The present invention relates to a computer system for running one or more programs and including a memory having at least a first heap and a second heap in which objects are stored, and a reset facility for the second heap.

### BACKGROUND OF THE INVENTION

Programs written in the Java programming language (Java is a trademark of Sun Microsystems Inc) are generally run in a virtual machine environment, rather than directly on hardware. Thus a Java program is typically compiled into byte-code form, and then interpreted by a Java virtual machine (VM) into hardware commands for the platform on which the Java VM is executing. The Java VM itself is an application running on the underlying operating system. An important advantage of this approach is that Java applications can run on a very wide range of platforms, providing of course that a Java VM is available for each platform.

Java is an object-oriented language. Thus a Java program is formed from a set of class files having methods that represent sequences of instructions (somewhat akin to subroutines). A hierarchy of classes can be defined, with each class inheriting properties (including methods) from those classes which are above it in the hierarchy. For any given class in the hierarchy, its descendants (i.e. below it) are called subclasses, whilst its ancestors (i.e. above it) are called superclasses. At run-time objects are created as instantiations of these class files, and indeed the class files themselves are effectively loaded as objects. One Java object can call a method in another Java object. In recent years the Java environment has become very popular, and is described in many books, for example “Exploring Java” by Niemeyer and Peck, O'Reilly & Associates, 1996, USA, and “The Java Virtual Machine Specification” by Lindholm and Yellin, Addison-Wedley, 1997, USA.

The standard Java VM architecture is generally designed to run only a single application, although this can be multi-threaded. In a server environment used for database transactions and such-like, each transaction is typically performed as a separate application, rather than as different threads within an application. This is to ensure that every transaction starts with the Java VM in a clean state. In other words, a new Java VM is started for each transaction (i.e. for each new Java application). Unfortunately however this results in an initial delay in running the application (the reasons for this will be described in more detail later). The overhead due to this frequent starting and then stopping a JVM as successive transactions are processed is significant, and seriously degrades the scalability of Java server solutions.

Various attempts have been made to mitigate this problem. EP-962860-A describes a process whereby one Java VM can fork into a parent and a child process, this being quicker than setting up a fresh Java VM. The ability to run multiple processes in a Java-like system, thereby reducing overhead per application, is described in “Processes in KaffeOS: Isolation, Resource Management, and Sharing in Java” by G back, W Hsieh, and J Lepreau (see:flux/papers/kaffeos-osdi00/main.html at http:// www.cs.utah.edu/

Another approach is described in “Oracle JServer Scalability and Performance” by Jeremy Litzt, July 1999 (see:jserver_scalability_and_performance_twp.pdf) at http:www.oracle.com/database/documents/. The JServer product available from Oracle Corporation, USA, supports the concept of multiple sessions (a session effectively representing a transaction or application), each session including a JServer session. Each individual session appears to its JServer client to be a dedicated conventional JVM.

U.S. patent application Ser. No. 09/304160, filed Apr. 30, 1999 (“A long Running Reusable Extendible Virtual Machine”), assigned to IBM Corporation (IBM docket YOR9-1999-0170), discloses a virtual machine having two types of heap, a private heap and a shared heap. The former is intended primarily for storing application classes, whilst the latter is intended primarily for storing system classes and, as its name implies, is accessible to multiple VMs. A related idea is described in “Building a Java virtual machine for server applications: the JVM on OS/390” by Dillenberger et al, IBM Systems Journal, Vol 39/1, January 2000.

The above documents are focused primarily on the ability to easily run multiple Java VMs in parallel. A different (and potentially complementary) approach is based on a serial rather than parallel configuration. Thus it is desirable to run repeated transactions (i.e. applications) on the same Java VM, since this could avoid having to reload all the system classes at the start of each application. However, one difficulty with this is that each application expects to run on a fresh, clean, Java VM. There is a danger with serial re-use of a Java VM that the state left from a previous transaction somehow influences the outcome of a new transaction. This unpredictability is unacceptable in most circumstances.

U.S. provisional application 60/208268 filed May 31, 2000 in the name of IBM Corporation (IBM docket number YOR9-2000-0359) discloses the idea of having two heaps in a JVM. One of these is a transient heap, which is used to store transaction objects that will not persist into the next transaction, whilst a second, persistent, heap is used for storing objects, such as system objects, that will persist. This approach provides the basis for an efficient reset mechanism by deleting the transient heap.

This concept is developed in GB application 0027045.4, filed Nov. 6, 2000 in the name of IBM Corporation (IBM docket number GB9-2000-0101), which focuses particularly on the deletion of the transient heap. One difficulty that arises at reset is how to handle pointers from objects in the persistent heap to objects the transient heap, since following reset and deletion of the transient heap, these pointers will no longer be valid. The general policy in the above application is that if such cross-heap pointers exist, the Java VM is no longer resettable, and so will normally have to be terminated.

However, it is possible that the objects in the persistent heap from which the cross-heap pointers originate are in fact no longer live, but are waiting to be garbage collected (the process of garbage collection in Java is described in more detail below). It is clearly undesirable to terminate the Java VM as unresettable simply on the basis of a cross-heap pointer that could possibly be deleted. Therefore, as described in the above application, if any cross-heap pointers are found at reset, a garbage collection operation is performed, which will remove any objects that are no longer live. In many cases this will eliminate all the objects that have the cross-heap pointers, thereby allowing reset to proceed.

Although the approach in the GB 0027045.4 application is effective, it suffers from the problem that garbage collection is a relatively time-consuming operation. Thus if any cross-heap pointers are found, there is a significant wait while the garbage collection is performed in order to determine whether or not the Java VM is safe to reset. This wait is unfortunate, given that one of the main motivations for being able to reset the Java VM in the first place was to overcome the start-up delay when having to launching a new Java VM for each transaction.

### SUMMARY OF THE INVENTION

Accordingly, the invention provides a computer system for running one or more programs and including a memory having at least a first heap and a second heap in which objects are stored, wherein a first object is stored on said first heap, said system further including:

a write barrier for detecting that said first object has been updated by a program to include a first reference to a memory location in said second heap, said write barrier including means for outputting a cross-heap event specifying information about said first reference and the current state of said program; and

a reset facility for the second heap whereby all objects stored within the second heap are deleted, said reset facility including means responsive to the detection of a second reference from the first heap to the second heap for outputting a reset event specifying information about said second reference, wherein the information in said reset event can be combined with the information in said cross-heap event to determine if said first reference matches said second reference.

Thus references from the first heap to the second heap (cross-heap references) can affect system performance, and in particular, the presence of such a cross-heap reference can prevent reset (deletion) of the second heap. The present invention provides instrumentation to permit a problematic cross-heap reference at reset to be tied back to its original creation by the program. This then greatly helps the programmer in understanding where in his or her code the problem is arising, and so aids in overcoming these reset problems.

Note that the first and second heaps do not need to be physically separate, but may for example be one heap logically partitioned into two or more heaps. In addition, there may be large number of logically separate heaps, and also a variety of different heap models, such as providing local heaps for threads. In this context a cross-heap pointer should simply be interpreted as a pointer from a heap that is not being reset into a heap that is being reset.

In the preferred embodiment, the information in the cross-heap event about the first reference comprises the address of the reference in the first heap, and the address of an object in the second heap to which the first reference points. In equivalent fashion the information in the cross-heap event about the second reference comprises the address of the reference in the first heap, and the address of an object in the second heap to which the second reference points. The first reference matches the second reference if (a) the address of the first reference in the first heap equals the address of the second reference in the first heap; and (b) the object in the second heap to which the first reference points is the same as the object in the second heap to which the second reference points.

It is preferred that the information in the cross-heap event about the current state of the program includes a stack dump. This is an important diagnostic which a developer can use to determine a troublespot within the code.

As previously mentioned, the presence of a single cross-heap reference from the first heap to the second heap at reset is sufficient to prevent deletion of the second heap (in the preferred embodiment this causes a type of reset event termed an Unresettable event). It is therefore preferred that the reset facility is responsive to the detection of any cross-heap references to make an attempt to eliminate them; the deletion of the second heap is only prevented if this attempt is unsuccessful.

The preferred embodiment further supports another type of reset event, termed a ResetTrace event. This event is output in response to the detection of a cross-heap reference prior to the attempt to eliminate such references. Both the Unresettable and ResetTrace events preferably output the from address of the offending cross-heap reference, and also the object that it is pointing to. Note that some systems may decide to support only a single type of reset event (either ResetTrace or Unresettable), although this will result in less diagnostic information being available.

The information from the two types of reset event allows an original crossheap event to be traced through a ResetTrace event to an Unresettable event—the final event only being present if the attempt at reset to eliminate the crossheap pointer is unsuccessful). Working the other way, the problems at reset can be tracked back to the original creation of the cross-heap reference, and the associated stack dump stored as part of the cross-heap event. This then provides valuable information for the programmer to avoid future reset problems.

One complication is that in the preferred embodiment, if certain objects in the second heap are referenced from the first heap, then these objects may be promoted to the first heap. This eliminates the original crossheap pointer, but may create new ones if the promoted object itself references objects in the second heap. Indeed, it is not uncommon for the promoted object to reference an object in the second heap, which is consequently promoted, which itself references an object in the second heap, leading to that object in turn being promoted, and so on. In the preferred embodiment, such promotions do not generate cross-heap events, but each such promotion does trigger a promotion event specifying information about an object before and after it is promoted.

Using the information recorded with promotion events, it is possible to track back from a reset event (eg ResetTrace or Unresettable) to a crossheap event, or from a ResetTrace event to an Unresettable event, even if there are one or more intervening promotions. The basic strategy when tracking back, for example if a corresponding crossheap event cannot be found to match a reset event, is as follows. The address of the crossheap reference is ascertained from the event information, and a promotion event identified for which the promoted object includes this address. This promotion is therefore assumed to be the immediate cause of the cross-heap event; however it is desirable to track back to see if the original cause of the promotion itself can be determined. This involves looking for a crossheap event which identifies a cross-heap reference to the promoted object prior to its promotion; it is this cross-heap reference which has caused the promotion, which in turn led to the reset event. Note that if there are many sequential promotions, this back-tracking has to be performed recursively through each promotion.

In practical situations the number of events generated can be rather large. Accordingly, the computer system of the present invention preferably includes a tool to perform matching of the different events (eg linking a crossheap event to its corresponding reset event or events, via any promotion events if necessary). In addition, a particular piece of code can also generate many similar crossheap events. Therefore the tool preferably also filters the matched events, so that only one event chain is presented for each code location (as determined from the stack dump).

To recap therefore, a write barrier is utilised to register writing of addresses in the second heap into locations in the first heap. This leads to event firing during execution of the relevant program (such as a transaction on the Java VM). Further events are also generated at strategic points within the reset of the second heap. Overall, this leads to a mechanism for tracing back from a cross-heap reference found at reset to the originating line of code which wrote the reference.

The invention further provides a method of operating a computer system for running one or more programs and including a memory having at least a first heap and a second heap in which objects are stored, wherein a first object is stored on said first heap, said method including the steps of:

detecting that said first object has been updated by a program to include a first reference to a memory location in said second heap,

outputting in response to such detection a cross-heap event specifying information about said first reference and the current state of said program;

providing a facility for resetting for the second heap whereby all objects stored within the second heap are deleted;

detecting as part of the resetting a second reference from the first heap to the second heap; and

outputting in response to such detection a reset event specifying information about said second reference;

wherein the information in said reset event can be combined with the information in said cross-heap event to determine if said first reference matches said second reference.

The invention further provides a computer program product comprising instructions encoded on a computer readable medium for causing a computer to perform the methods described above. A suitable computer readable medium may be a DVD or computer disk, or the instructions may be encoded in a signal transmitted over a network from a server.

It will be appreciated that the methods and computer program product of the invention will benefit from the same preferred features as the systems of the invention.

### BRIEF DESCRIPTION OF THE DRAWINGS

A preferred embodiment of the invention will now be described in detail by way of example only with reference to the following drawings:

FIG. 1 shows a schematic diagram of a computer system supporting a Java Virtual Machine (VM);

FIG. 2 is a schematic diagram of the internal structure of the Java VM;

FIG. 3 is a flowchart depicting the steps required to load a class and prepare it for use;

FIG. 4 is a flowchart depicting at a high level the serial reuse of a JVM;

FIG. 5 is a schematic diagram showing the heap and its associated components in more detail;

FIGS. 6A and 6B form a flowchart illustrating garbage collection;

FIG. 7 is a diagram of a lookup table used to determine if a reference is in a heap;

FIG. 8 is a diagram of a modified lookup structure for the same purpose as FIG. 7, but for use in a system with much larger memory;

FIGS. 9A and 9B form a flowchart illustrating the operations taken to delete the transient heap during Java VM reset;

FIG. 10 is a schematic diagram illustrating a cross-heap pointer;

FIG. 11 is a flowchart illustrating the operation of the write barrier that generates crossheap events;

FIG. 12 is a flowchart illustrating the sorting of events in relation to crossheap pointers;

FIG. 13 is a diagram illustrating the effect of a promotion event; and

FIG. 14 is a diagram illustrating the effect of a chain of promotion events.

### DETAILED DESCRIPTION

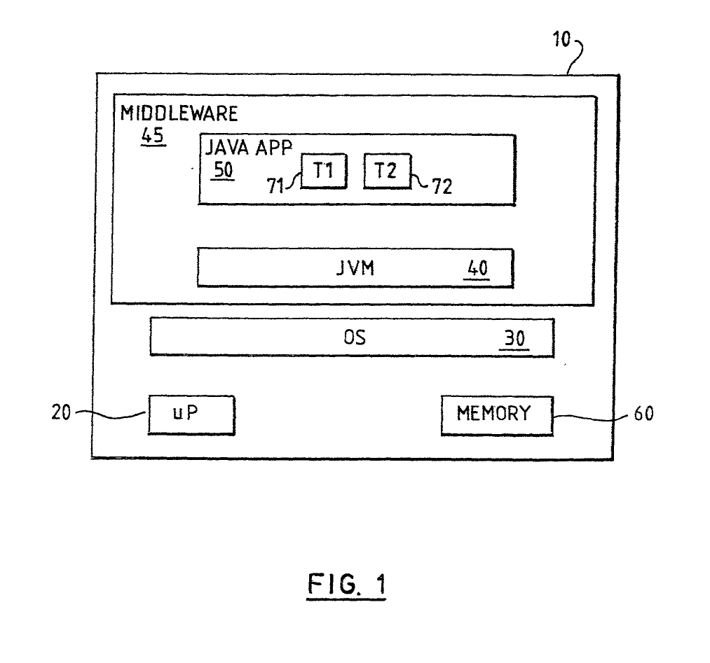

FIG. 1 illustrates a computer system 10 including a (micro)processor 20 which is used to run software loaded into memory 60. The software can be loaded into the memory by various means (not shown), for example from a removable storage device such as a floppy disk, CD ROM, or DVD, or over a network such as a local area network (LAN), telephone/modem connection, or wireless link, typically via a hard disk drive (also not shown). Computer system runs an operating system (OS) 30, on top of which is provided a Java virtual machine (VM) 40. The Java VM looks like an application to the (native) OS 30, but in fact functions itself as a virtual operating system, supporting Java application 50. A Java application may include multiple threads, illustrated by threads T1 and T2 71, 72.

System 10 also supports middleware subsystem 45, for example a transaction processing environment such as CICS, available from IBM Corporation (CICS is a trademark of IBM Corporation). The middleware subsystem runs as an application or environment on operating system 30, and initiates the Java VM 40. The middleware also includes Java programming which acts to cause transactions as Java applications 50 to run on top of the Java VM 40. In accordance with the present invention, and as will be described in more detail below, the middleware can cause successive transactions to run on the same Java VM. In a typical server environment, multiple Java VMs may be running on computer system 10, in one or more middleware environments.

It will be appreciated that computer system 10 can be a standard personal computer or workstation, network computer, minicomputer, mainframe, or any other suitable computing device, and will typically include many other components (not shown) such as display screen, keyboard, sound card, network adapter card, etc which are not directly relevant to an understanding of the present invention. Note that computer system 10 may also be an embedded system, such as a set top box, handheld device, or any other hardware device including a processor 20 and control software 30, 40.

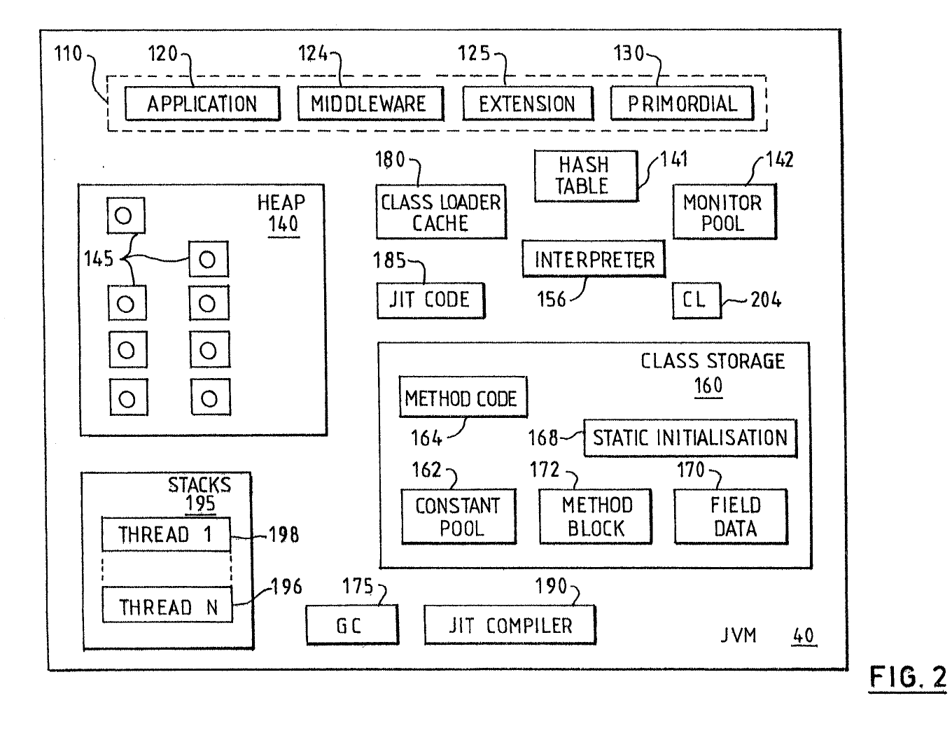

FIG. 2 shows the structure of Java VM 40 in more detail (omitting some components which are not directly pertinent to an understanding of the present invention). The fundamental unit of a Java program is the class, and thus in order to run any application the Java VM must first load the classes forming and required by that application. For this purpose the Java VM includes a hierarchy of class loaders 110, which conventionally includes three particular class loaders, named Application 120, Extension 125, and Primordial 130. An application can add additional class loaders to the Java VM (a class loader is itself effectively a Java program). In the preferred embodiment of the present invention, a fourth class loader is also supported, Middleware 124.

For each class included within or referenced by a program, the Java VM effectively walks up the class loader hierarchy, going first to the Application class loader, then the Middleware loader, then the Extension class loader, and finally to the Primordial class loader, to see if any class loader has previously loaded the class. If the response from all of the class loaders is negative, then the JVM walks back down the hierarchy, with the Primordial class loader first attempting to locate the class, by searching in the locations specified in its class path definition. If this is unsuccessful, the Extension class loader then makes a similar attempt, if this fails the Middleware class loader tries. Finally, if this fails the Application class loader tries to load the class from one of the locations specified in its class path (if this fails, or if there is some other problem such as a security violation, the system returns an error). It will be appreciated that a different class path can be defined for each class loader.

The Java VM further includes a component CL 204, which also represents a class loader unit, but at a lower level. In other words, this is the component that actually interacts with the operating system to perform the class loading on behalf of the different (Java) class loaders 110.

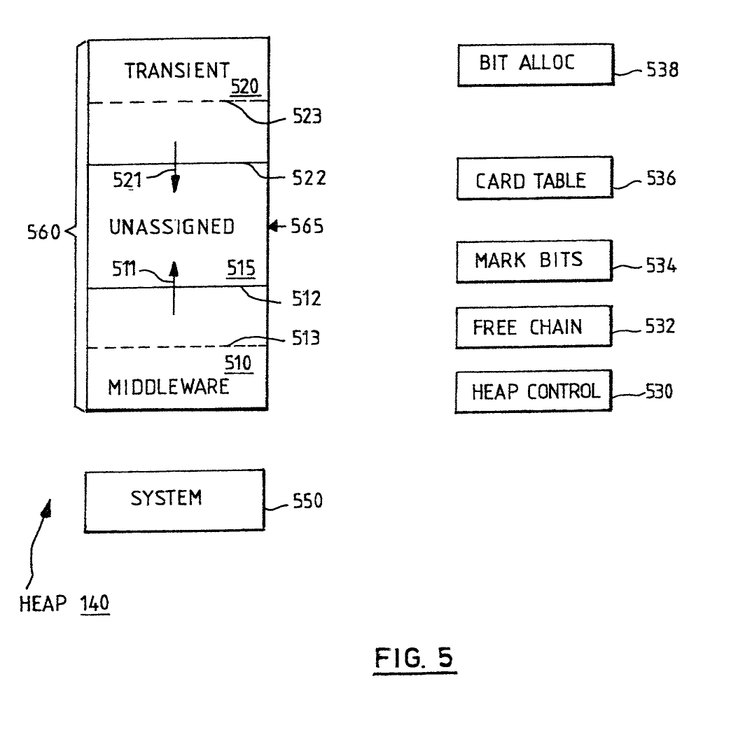

Also present in the Java VM is a heap 140, which is used for storage of objects 145 (FIG. 2 shows the heap 140 only at a high level; see FIG. 5 below for more details). Each loaded class represents an object, and therefore can be found on the heap. In Java a class effectively defines a type of object, and this is then instantiated one or more times in order to utilise the object. Each such instance is itself an object which can be found in heap 140. Thus the objects 145 shown in the heap in FIG. 2 may represent class objects or other object instances. (Note that strictly the class loaders as objects are also stored on heap 140, although for the sake of clarity they are shown separately in FIG. 2). Although heap 140 is shared between all threads, typically for reasons of operational efficiency, certain portions of heap 140 can be assigned to individual threads, effectively as a small region of local storage, which can be used in a similar fashion to a cache for that thread.

The Java VM also includes a class storage area 160, which is used for storing information relating to the class files stored as objects in the heap 140. This area includes the method code region 164 for storing byte code for implementing application logic such as class method calls, and a constant pool 162 for storing strings and other constants associated with a class. The class storage area also includes a field data region 170 for sharing static variables (static in this case implies belonging to the class rather than individual instances of the class, or, to put this another way, shared between all instances of a class), and an area 168 for storing static initialisation methods and other specialised methods (separate from the main method code 164). The class storage area further includes a method block area 172, which is used to store information relating to the code, such as invokers, and a pointer to the code, which may for example be in method code area 164, in JIT code area 185 (as described in more detail below), or loaded as native code such as C, for example as a dynamic link library (DLL).

Classes stored as objects 145 in the heap 140 contain a reference to their associated data such as method byte code etc in class storage area 160. They also contain a reference to the class loader which loaded them into the heap, plus other fields such as a flag (not shown) to indicate whether or not they have been initialised.

FIG. 2 further shows a monitor pool 142. This contains a set of locks (monitors) that are used to control access to an object by different threads. Thus when a thread requires exclusive access to an object, it first obtains ownership of its corresponding monitor. Each monitor can maintain a queue of threads waiting for access to any particular object. Hash table 141 is used to map from an object in the heap to its associated monitor.

Another component of the Java VM is the interpreter 156, which is responsible for reading in Java byte code from loaded classes, and converting this into machine instructions for the relevant platform. From the perspective of a Java application, the interpreter effectively simulates the operation of a processor for the virtual machine.

Also included within the Java VM are class loader cache 180 and garbage collection (GC) unit 175. The former is effectively a table used to allow a class loader to trace those classes which it initially loaded into the Java VM. The class loader cache therefore allows each class loader to check whether it has loaded a particular class—part of the operation of walking the class loader hierarchy described above. Note also that it is part of the overall security policy of the Java VM that classes will typically have different levels of permission within the system based on the identity of the class loader by which they were originally loaded.

Garbage collection (GC) facility 175 is used to delete objects from heap 140 when those objects are no longer required. Thus in the Java programming language, applications do not need to specifically request or release memory, rather this is controlled by the Java VM. Therefore, when Java application 50 creates an object 145, the Java VM secures the requisite memory resource. Then, when Java application 50 finishes using object 145, the Java VM can delete the object to free up this memory resource. This latter process is known as garbage collection, and is generally performed by briefly interrupting all threads 71, 72, and scanning the heap 140 for objects which are no longer referenced, and hence can be deleted. The garbage collection of the preferred embodiment is described in more detail below.

The Java VM further includes a just-in-time (JIT) compiler 190. This forms machine code to run directly on the native platform by a compilation process from the class files. The machine code is created typically when the application program is started up or when some other usage criterion is met, and is then stored for future use. This improves run-time performance by avoiding the need for this code to be interpreted later by the interpreter 156.

Another component of the Java VM is the stack area 195, which is used for storing the stacks 196, 198 associated with the execution of different threads on the Java VM. Note that because the system libraries and indeed parts of the Java VM itself are written in Java, and these frequently use multi-threading, the Java VM may be supporting multiple threads even if the user application 50 running on top of the Java VM contains only a single thread itself.

It will be appreciated of course that FIG. 2 is simplified, and essentially shows only those components pertinent to an understanding of the present invention. Thus for example the heap may contain thousands of Java objects in order to run Java application 50, and the Java VM contains many other components (not shown) such as diagnostic facilities, etc.

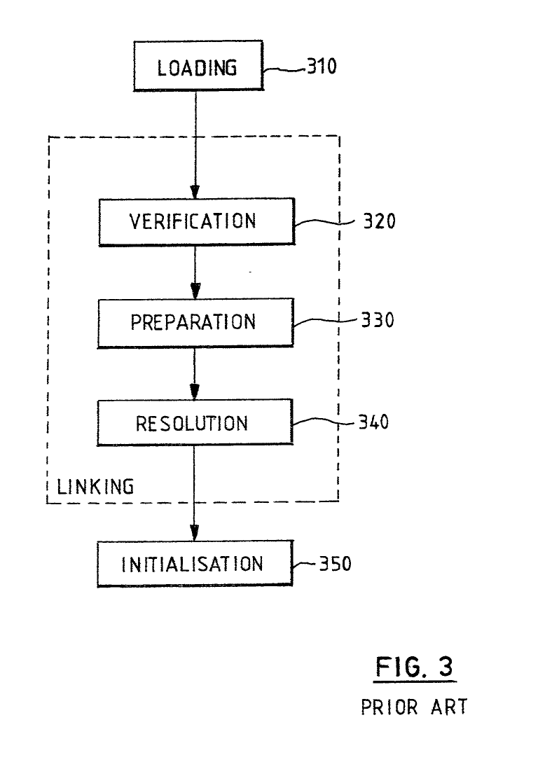

FIG. 3 is a flowchart illustrating the operations conventionally performed to load a class in order to run a Java application. The first operation is loading (step 310) in which the various class loaders try to retrieve and load a particular class. The next operation is linking, which comprises three separate steps. The first of these is verification (step 320), which essentially checks that the code represents valid Java programming, for example that each instruction has a valid operational code, and that each branch instruction goes to the beginning of another instruction (rather than the middle of an instruction). This is followed by preparation (step 330) which amongst other things creates the static fields for a class. The linking process is completed by the step of resolution, in which a symbolic reference to another class is typically replaced by a direct reference (step 340).

At resolution the Java VM may also try to load additional classes associated with the current class. For example, if the current class calls a method in a second class then the second class may be loaded now. Likewise, if the current class inherits from a superclass, then the superclass may also be loaded now. This can then be pursued recursively; in other words, if the second class calls methods in further classes, or has one or more superclasses, these too may now be loaded. Note that it is up to the Java VM implementation how many classes are loaded at this stage, as opposed to waiting until such classes are actually needed before loading them.

The final step in FIG. 3 is the initialisation of a loaded class (step 350), which represents calling the static initialisation method (or methods) of the class. According to the formal Java VM specification, this initialisation must be performed once and only once before the first active use of a class, and includes things such as setting static (class) variables to their initial values (see the above-mentioned book by Lindholm and Yellin for a definition of “first active use”). Note that initialisation of an object also requires initialisation of its superclasses, and so this may involve recursion up a superclass tree in a similar manner to that described for resolution. The initialisation flag in a class object 145 is set as part of the initialisation process, thereby ensuring that the class initialisation is not subsequently re-run.

The end result of the processing of FIG. 3 is that a class has been loaded into a consistent and predictable state, and is now available to interact with other classes. In fact, typically at start up of a Java program and its concomitant Java VM, some 1000 objects are loaded prior to actual running of the Java program itself, these being created from many different classes. This gives some idea of the initial delay and overhead involved in beginning a Java application.

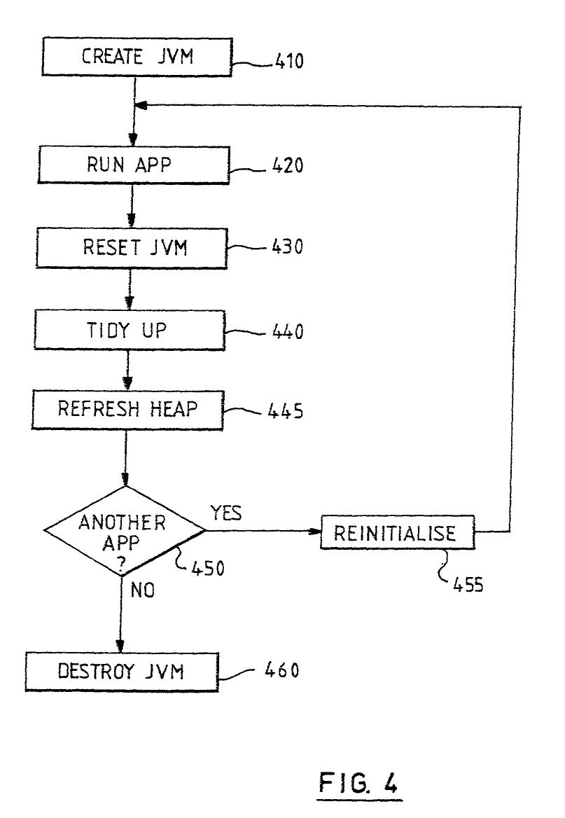

As mentioned above, the problems caused by this initial delay can be greatly reduced by serial reuse of a Java VM, thereby avoiding the need to reload system classes and so on. FIG. 4 provides a high-level flowchart of a preferred method for achieving such serial reuse. The method commences with the start of the middleware subsystem 45, which in turn uses the Java Native Interface (JNI) to perform a Create JVM operation (step 410). Next an application or transaction to run on the Java VM is loaded by the Application class loader 120. The middleware includes Java routines to provide various services to the application, and these are also loaded at this point, by the Middleware class loader 124.

The application can now be run (step 420), and in due course will finally terminate. At this point, instead of terminating the Java VM as well as the application, the middleware subsystem makes a Reset JVM call to the Java VM (step 430). The middleware classes may optionally include a tidy-up method and/or a reinitialize method. Both of these are static methods. The Java VM responds to the Reset JVM by calling the tidy-up method of the middleware classes (step 440). The purpose of this is to allow the middleware to leave the Java VM in a tidy state, for example removing resources and closing files that are no longer required, and deleting references to the application objects. In particular, all those middleware classes which have been used since the previous Java VM reset (or since the Java VM was created if no resets have occurred) have their tidy-up method called, assuming of course that they have a tidy-up method (there is no requirement for them to have such a tidy-up method).

The tidy-up method may be similar to the finalise method of a class, which is a standard Java facility to allow an object to perform some close-down operation. However, there is an important difference in that tidy-up is a static method. This means that contrary to the finalise method it applies to the class rather than any particular object instance, and so will be called even if there are no current object instances for that class. In addition the timing of the tidy-up method is different from finalise, in that the former is called in response to a predetermined command to reset the Java VM. In contrast, in accordance with the Java VM specification, the finalise method is only triggered by a garbage collection. More particularly, if an object with a finalizer method is found to be unreachable during a garbage collection (ie it is no longer effectively active) then it is queued to the finalizer thread, which then runs the finalizer method after the garbage collection is completed. Note that the finalizer method of an object may never be called, if an application finishes and the Java VM shuts down without the system needing to perform a garbage collection.

Once the tidy-up has been completed, a refresh heap operation is performed (step 445). As will be described in more detail below, this deletes those portions of the heap that relate to the application or transaction that has just been completed, generally analogous to a garbage collection cycle. Note that many of the objects deleted here might not have been removable prior to the tidy-up method, since they could still have been referenced by the middleware classes.

At this point, the middleware subsystem makes a determination of whether or not there is another application to run on the Java VM (step 450). If not, the middleware subsystem uses the JNI to make a Destroy JVM call (step 460) which terminates the Java VM, thereby ending the method of FIG. 4. If on the other hand there is another application to run, then this new application is started by the middleware. The system responds to this new application by calling in due course the reinitialisation method in each of the middleware classes to be reused (step 455). The purpose of this is to allow the middleware classes to perform certain operations which they might do at initialisation, thereby sidestepping the restriction that the Java VM specification prevents the initialisation method itself being called more than once. As a simple example, the reinitialisation may be used to reset a clock or a counter. As shown in FIG. 4, the system is now in a position to loop round and run another application (step 420).

It is generally expected that the reinitialisation method will be similar in function to the initialisation method, but there may well be some differences. For example, it may be desired to reset static variables which were initialised implicitly. Another possibility is to allow some state or resources to persist between applications; for example, if a class always outputs to one particular log file which is set up by the initialisation method, it may be more efficient to keep this open in between successive Java VMs, transparent to the application.

It should be noted that whilst FIG. 4 indicates the distinct logical steps performed by the method of the invention, in practice these steps are not all independent. For example, calling the tidy-up methods (step 440) is part of the overall Reset JVM operation (step 430). Likewise, calling the reinitialisation methods (step 455) is effectively part of the start-up processing of running the new application (step 420). Thus reinitialisation is performed prior to first active use of a class, and this may occur at any stage of a program. Therefore class reinitialisation (like conventional initialisation) is not necessarily completed at start-up of the program, but rather can be regarded as potentially an ongoing process throughout the running of a program.

It will also be appreciated that there is some flexibility with regard to the ordering of the steps shown in FIG. 4. In particular, the decision of whether or not there is to be another application (step 450) could be performed earlier, such as prior to the refresh heap step, the tidyup step, and/or the Reset JVM step. In the latter case, which corresponds to immediately after the first application has concluded (i.e. straight after step 420), the alternative outcomes would be to destroy the Java VM (step 460) if there were no further applications, or else to reset the JVM, tidy up, refresh the heap, and reinitialise (steps 430, 440, 445, and 455) if there were further applications. If instead the decision step 450 is intermediate these above two extreme positions, the logic flow can be determined accordingly.

It should be noted that in the preferred embodiment, the ability to reset the Java VM, and to have tidyup and reinitialise methods, is only available for middleware classes (i.e. those loaded by the middleware class loader). This is to allow the middleware classes to be re-used by successive applications or transactions, for which they can perform various services. The basis for this approach is that typically the middleware is a relatively sophisticated and trusted application, and so can be allowed to take responsibility for proper implementation of the tidy-up and reinitialise methods. On the other hand, individual transactions are not treated as reliable.

Note also that the system classes themselves do not have tidyup or reinitialisation methods, despite persisting across a Java VM reset. Rather, if the middleware makes any change to a system class, then the middleware itself is expected to take the necessary action (if any) for a reset with respect to the system class as part of the middleware's own tidyup operation.

An important part of the Reset JVM/tidyup operation (steps 430 and 440) in the preferred embodiment is to make sure that the Java VM is in a state which is amenable to being tidied up. If this is the case, the Java VM is regarded as being clean, if not, it is regarded as being dirty or unresettable.

Considering this in more detail, if the application has performed certain operations, then it will not be possible for the middleware classes to be certain that their tidy-up and reinitialise methods will fully reset the system to a fresh state. With such a contaminated Java VM, the system still calls the tidy-up methods of the class objects as per normal (step 440), but the return code back to the middleware associated with the reset JVM operation (step 430) effectively indicates failure. The expectation here is that the Java VM would actually be terminated by the middleware subsystem at this point, as it is no longer in a predictable condition.

One important situation which would prevent the Java VM from being able to properly reset is where the application has performed certain operations directly such as making security or environment changes, loading native code, or performing Abstract Windowing Toolkit (AWT) operations. These affect the state of the Java VM or the underlying computer system and cannot be reliably tidied up by the middleware, for the simple reason that the middleware does not necessarily know about them. Such changes could then persist through a Reset JVM call, and contaminate the Java VM for any future applications. In contrast, if an application performs such operations through a middleware call, then this does not cause any problems, because the middleware now does know about the situation and so can perform whatever tidyup measures are required.

The Java VM thus monitors for operations that may prevent proper reset, including whether they have been performed by an application or middleware. This is determined by the Java VM keeping track of its context, which is set to application context for an application class, and to middleware context for a middleware class, whilst a primordial or extension class has no impact on the existing context of application or middleware. In particular, context can be determined based on the type of class which contains the method that is currently being performed, whilst the type of class is determined from its original class loader.

As previously mentioned, the list of problematic operations given above only causes difficulty when performed in an application context, since in a middleware context it is possible for them to be reset by the appropriate tidy-up routines of the relevant middleware classes.

Referring now to FIG. 5, in the preferred embodiment the heap 140 is logically split into three components (objects in one component can reference objects in another component). In particular, at the bottom (logically) of heap 140 is middleware section 510, and at the top of the heap is transient section 520. The data in these two heaps grows towards each other, thus transient heap grows in the direction of arrow 521, and middleware heap in the direction of arrow 511. The middleware heap is defined by boundary 512, and the transient heap by boundary 522, with unassigned space 515 between them. It should be appreciated that boundaries 512 and 522 represent the maximum size currently assigned to the two heaps, rather than their current fill levels—these are instead shown by dashed lines 513 and 523. In other words, as the middleware heap fills up, the fill level 513 will approach towards middleware heap boundary 512; likewise as the transient heap fills up, the fill level 523 will approach towards transient heap boundary 522. Finally, and separate from the transient heap and middleware heap, is system heap 550. Note that the combined transient and middleware heaps, together with intervening unassigned space, are allocated from a single physically contiguous block of memory 560. In contrast, the system heap 550 may be formed from multiple non-contiguous regions of memory.

In one preferred embodiment, memory 560 comprises 64 MBytes, and the initial size of the middleware and transient heaps is 0.5 Mbyte each. Thus it can be seen that initially the unassigned region 515 dominates, although the transient and middleware heaps are allowed to expand into this space (details of the expansion policy are provided in the above mentioned GB 0027045.4 application). However, these values are exemplary only, and suitable values will vary widely according to machine architecture and size, and also the type of application.

Heap control block 530 is used for storing various information about the heap, such as the location of the heap within memory, and the limits of the transient and middleware sections as defined by limits 512 and 522. Free chain block 532 is used for listing available storage locations within the middleware and transient sections (there is actually one free chain block for each section). Thus although the middleware and transient heaps start to fill sequentially, the likely result of a garbage collection cycle is that space may become available within a previously occupied region. Typically therefore there is no single fill line such as 513, 523 between vacant and occupied space, rather a fragmented pattern. The free chain block is a linked list which specifies the location and size of empty regions within that section of the heap. It is quick to determine whether and where a requested amount of storage is available in the heap by simply scanning through the linked list. Note that in the preferred embodiment, empty regions in the heap which are below a predetermined size (typically a few hundred bytes) are excluded from the free chain list. This prevents the list from becoming too long through containing a large number of very small vacant regions, although it does mean that these regions effectively become inaccessible for storage (although they can be retrieved later, as described in more detail below).

The transient heap 520 is used for storing objects having no expected currency beyond the end of the application or transaction, including application object instances, and primordial object instances and arrays created by application methods (arrays can be regarded as a specialised form of object). Since the lifetime of such objects is commensurate with the application itself, it should be possible to delete all the objects in the transient heap at the end of the application. The application class objects are also on the transient heap. In contrast, the middleware heap 510 is used for storing objects which have a life expectancy longer than a single transaction, including middleware object instances, and primordial object instances and arrays created by middleware methods. In addition, string objects and arrays for strings interned in the Interned String Table are also stored in the middleware heap (the Interned String Table is a tool whereby if multiple identical strings are to be stored on the heap, it is possible to store only one copy of the string itself, which can then be referenced elsewhere). Lastly, the system heap 550 is used for storing primordial class objects and reusable class objects, where the term reusable class object is used to denote a class which can be used again after JVM reset.

The type of class is dependent on the class loader which originally loaded it, in other words a middleware class and an application class are loaded by the middleware class loader 124 and the application class loader 120 respectively. For the purposes of the present discussion, primordial classes can be considered as classes loaded by the Primordial or Extensions class loader (130 and 125 respectively in FIG. 2). In the preferred embodiment, classes loaded by the middleware class loader are automatically regarded as reusable.

Instances of primordial classes, such as the basic string class java/lang/String, can be located either in the middleware heap or the transient heap, depending on the method which created them. In a preferred embodiment of the present invention, the determination of where to place such primordial class instances is based on the current context described above (also referred to as method-type). Thus if a method belonging to an application class is invoked, the context or method-type becomes Application, whilst if a method belonging to a middleware class is invoked, the method-type becomes Middleware. Finally, if a method belonging to a primordial class is invoked, the method-type is unchanged from its previous value. The context or method-type is stored in the Java frame for the method (which is stored on stack 195—see FIG. 2); at the completion of the method, the method-type reverts to its value at the time the method was invoked, which was stored in the previous frame.

It should be noted that for the above purpose a method belongs to the class that actually defines it. For example, if class A subclasses class B, but does not override method C, then method C belongs to class B. Therefore the method-type is that of class B, even if method C is being run for an instance of class A. In addition, the reason for tracking method-type on a per-thread basis is that it is possible for various threads within an application to be executing different methods having different context.

The transient region of the heap, containing objects created by the application or transaction, is subject to normal garbage collection. However, the intention is that it will be sufficiently large that this is unlikely to occur within the lifetime of a typical application, since as previously mentioned garbage collection is a relatively slow operation. At the end of each application, the transient region of the heap is reset. (The repetition of this pattern will thereby avoid having to perform garbage collection during most applications). In contrast the middleware region generally contains objects created by the trusted middleware. It is again subject to conventional garbage collection, although in a transaction environment it is expected that the majority of objects will be created in the transient heap, so that garbage collection is not expected to occur frequently. The middleware heap is not cleared between applications, but rather remains to give the middleware access to its persistent state (it is assumed that the middleware can take responsibility for resetting itself to the correct state to run the next application).

The preferred embodiment is actually somewhat more complicated than described above, in that it supports two types of application class loader, one of which is for standard application classes, the other for reusable application classes. The motivation here is that when the next transaction is to run, it will in fact require many of the same application classes as the previous transaction. Therefore it is desirable to retain some application system classes rather than having to reload them, although certain additional processing is required to make them look newly loaded to the next transaction. Conversely it would be possible to have a second middleware class loader which is for non-reusable middleware classes. In the former situation the reusable application classes are treated essentially in the same manner as the reusable middleware classes, (eg loaded into the system heap); in the latter situation the non-reusable middleware classes would be treated similarly to the non-reusable application classes but loaded into the middleware heap (since they may exist after the conclusion of a transaction, even if they do not endure for the next transaction). However, for present purposes in order to explain the invention more clearly, it will be assumed that all the middleware classes are reusable, and that none of the application classes are reusable.

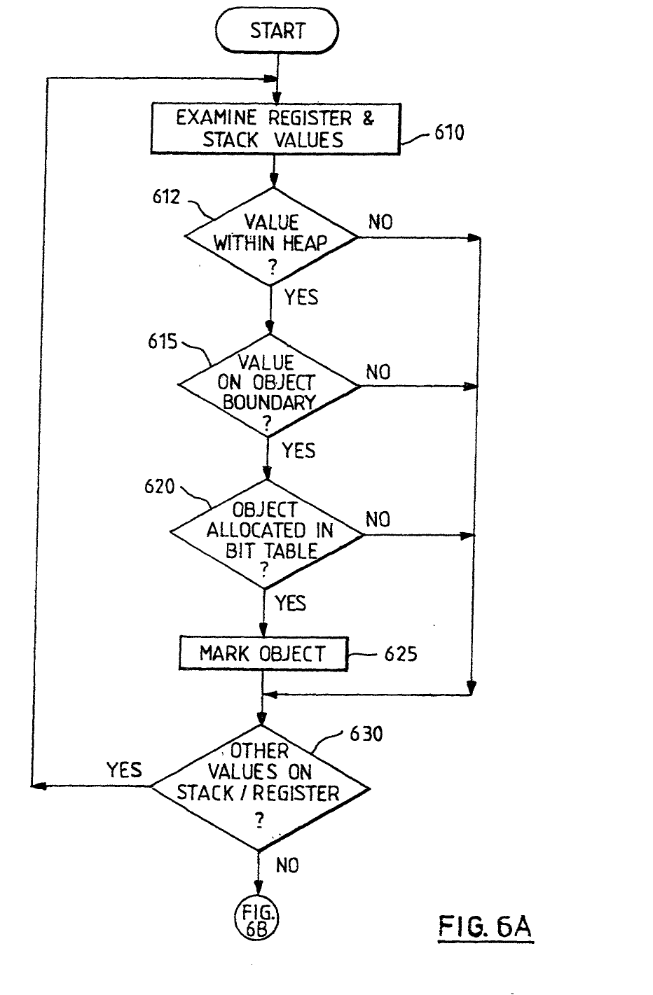

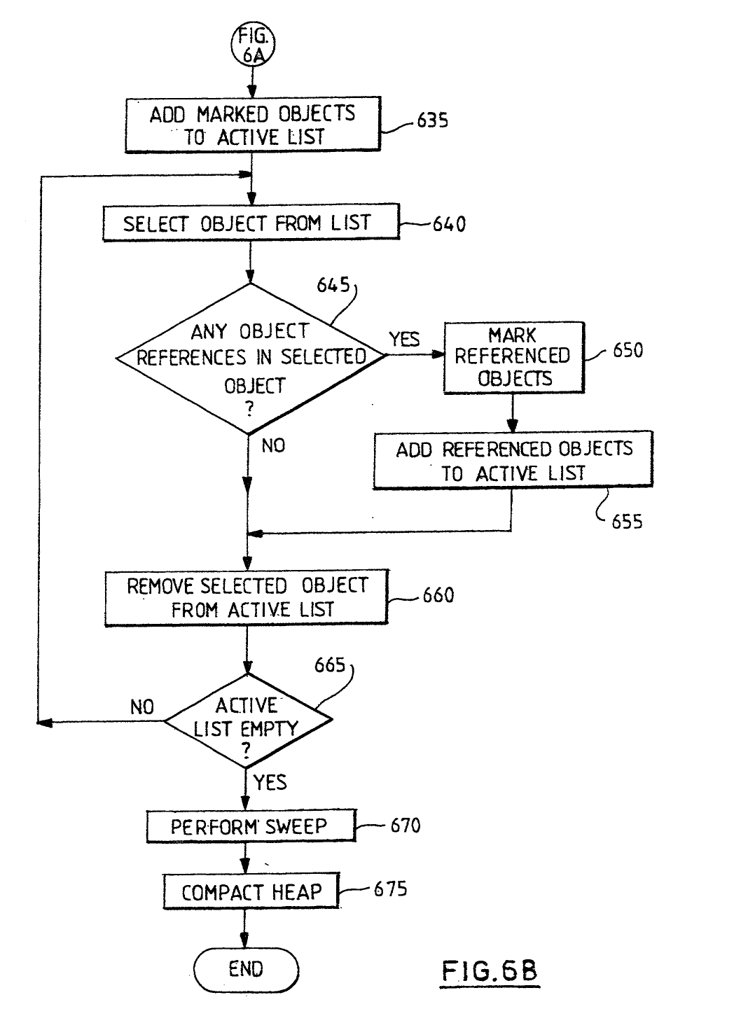

Referring now to FIGS. 6A and 6B, these illustrate the garbage collection strategy of the preferred embodiment. In particular, the method involves firstly a mark phase, which marks all objects in the heap that are currently in use (known as live or active objects), and secondly a sweep phase, which represents the actual deletion of objects from the heap. Note that general background on garbage collection algorithms can be found in “Garbage Collection: Algorithms for Automatic Dynamic Memory Management” by R Jones and R Lins, Wiley, 1996 (ISBN 0 471 94148 4), whilst one implementation for garbage collection in a system having multiple heaps is described in: “A customisable memory management framework for C++” by G Attardi, T Flagella, and P Iglio, in Software Practice and Experience, vol 28/11, 1998.

As shown in FIG. 6A, the method starts with a review of the registers and stack, both the Java stack, as shown in FIG. 2, and also the C stack, (assuming that the Java VM 40 is running as a C application on OS 30, see FIG. 1) (step 610). Each thirty-two bit data word (for a 32-bit system) contained therein could represent anything, for example a real number, or part of a string, but it is assumed at least initially that it may denote a 32 bit reference to an object location in the heap. To firm up on this assumption, three tests are made. Firstly, it is tested whether or not the number references a location within the heap (step 612); if not then the number cannot represent an object reference. Secondly, in the preferred embodiment, all objects commence on an 8-byte boundary. Thus if the location corresponding to the data word from the stack/register does not fall on an object boundary (tested at step 615), then the original assumption that the data/number represents a reference to the heap must again be rejected. Thirdly, in the preferred embodiment, a table 538 is maintained (see FIG. 5) which has a bit for each object location in the heap; this bit is set to unity if there is an object stored at that location, and zero if no object is stored at that location (the relevant bit is updated appropriately whenever an object is created, deleted, or moved). If the data word from the stack/register corresponds to an object location for which the bit is zero, in other words, no object at that location, then once more the original assumption that the data/number represents a reference to the heap must be rejected (step 620). If the data word passes all three of the tests of steps 612, 615 and 620, then there are three remaining possibilities: (a) the word references an object on the heap; (b) the word is an integer that happens to have the same value as the object reference; or (c) the word is a previous value from uninitialized storage. As a conservative measure, it is assumed that option (a) is correct, and so the object is marked as live (step 625). A special array of bits is provided (block 534, see FIG. 5), one bit per object, in order to store these mark bits. If there remain other values on the stacks/registers to test (step 630), the method then loops back to examine these in the same manner as just described; if not the first stage of the mark process is complete.

In the second stage of the mark process, shown in FIG. 6B, the objects marked as live are copied onto a list of active objects (step 635) (in the preferred embodiment objects are actually copied to the active list when originally marked, ie at the same time as step 625 in FIG. 6A). An object from this list is then selected (step 640), and examined to see if it contains any references (step 645). Note that this is a reasonably straightforward procedure, because the structure of the object is known from its corresponding class file, which defines the relevant variables to be used by the object. Any objects referenced by the selected object are themselves marked (step 650) and added to the active list (step 655). Next, the selected object is removed from the active list (step 660), and then a test is performed (step 665) to determine if the active list is empty; if not, processing loops back to step 640 to select another object from the active list. Finally, when step 665 produces a positive outcome, all objects that are active, because they are referenced directly or indirectly from the stacks or registers, have been appropriately marked.

The mark stage is then followed by a sweep stage (step 670) and a compact stage (step 675). The former garbage collects (ie deletes) all those objects which have not been marked, on the basis that they are no longer reachable from any live or active object. In particular, each object which is not marked as active has its corresponding bit set to zero in table 538 (see FIG. 5). Runs of zeros in the bit allocation table 538 are now identified; these correspond to some combination of the object immediately preceding the run, which may extend into the run (since only the head of an object is marked in the bit allocation table), and free space (released or never filled). The amount of free space in the run of zeros can be determined by examining the size of the object immediately preceding the run. If the amount of free space exceeds the predetermined minimum amount mentioned earlier, then the run is added to the free chain list 532 (see FIG. 5).

Over time, such sweeping will tend to produce many discontinuous vacant regions within the heap, corresponding to the pattern of deleted objects. This does not represent a particularly efficient configuration, and in addition there will be effective loss of those pieces of memory too small to be on the free list. Hence a compact stage (step 675) can be performed, which acts to squeeze together those objects which remain in the heap after the sweep in order to amass them into a single continuous block of storage (one for the transient heap, one for the middleware heap). Essentially, this means relocating objects from their initial positions in the heap, to a new position so that, as much as possible, they are all adjacent to one another. As part of this compaction, the very small regions of memory too small to be on the free chain 532 (see FIG. 5) should be aggregated into larger blocks that can be recorded in the free chain.

An important requirement of the object relocation of the compaction step is of course that references to a moved object are altered to point to its new location. This is a relatively straightforward operation for object references on the heap itself, since as previously mentioned, they can be identified from the known structure of each object, and updated to the appropriate new value. However, there is a problem with objects which are directly referenced from a register or stack. As discussed above, each number in the register/stack is treated for garbage collection purposes as if it were an object reference, but there is no certainty that this is actually the case; rather the number may represent an integer, a real number, or any other piece of data. It is therefore not possible to update any object references on the stack or register, because they may not in fact be an object reference, but rather some other piece of program data, which cannot of course be changed arbitrarily. The consequence of this is that it is impossible to move an object which appears to be directly referenced from the heap or stack; instead these objects must remain in their existing position. Such objects are informally known as “dozed” objects since they cannot be moved from their current position.

Two other classes of objects which cannot be moved from the heap are class objects, and thread objects (thread objects are control blocks used to store information about a thread). The reason for this is that such objects are referenced from so many other places in the system that it is not feasible to change all these other references. These objects are therefore known as “pinned”, since like dozed objects they cannot be moved from their current position.

A consequence of pinned and dozed objects is that a compact process may not be able to accumulate all objects in a heap into a single contiguous region of storage, in that pinned and dozed objects must remain in their original positions.

Note that in the preferred embodiment, a compact stage (step 675) is not necessarily employed on every garbage collection cycle, unless this is explicitly requested as a user initial set-up option. Rather a compact operation is only performed when certain predetermined criteria are met. For example, as previously indicated a garbage collection can be triggered by a request for storage in the heap that cannot be satisfied. If the request still cannot be satisfied after the sweep step 670, because there is no single block of memory available of sufficient size, then a compact stage is automatically performed, to try and accumulate an adequately-sized storage region.

An important aspect of the garbage collection process is that it operates by detecting all live objects; the remaining objects which are not live are then marked as dead. Consequently, for a given object, it is not possible to tell whether or not it is dead without effectively performing a full garbage collection.

One complication that arises from effectively having multiple heaps of potentially variable sizes is that it becomes more complex to determine whether or not a given object reference is within a heap (as required, for example, for step 612 of FIG. 6A), and if so which one (in case, for example, they have different garbage collection policies). One possibility is to compare the reference with the information in the heap control block 530 (see FIG. 5). However, with multiple heaps, and also a system heap which is not necessarily contiguous, this becomes a time-consuming operation.

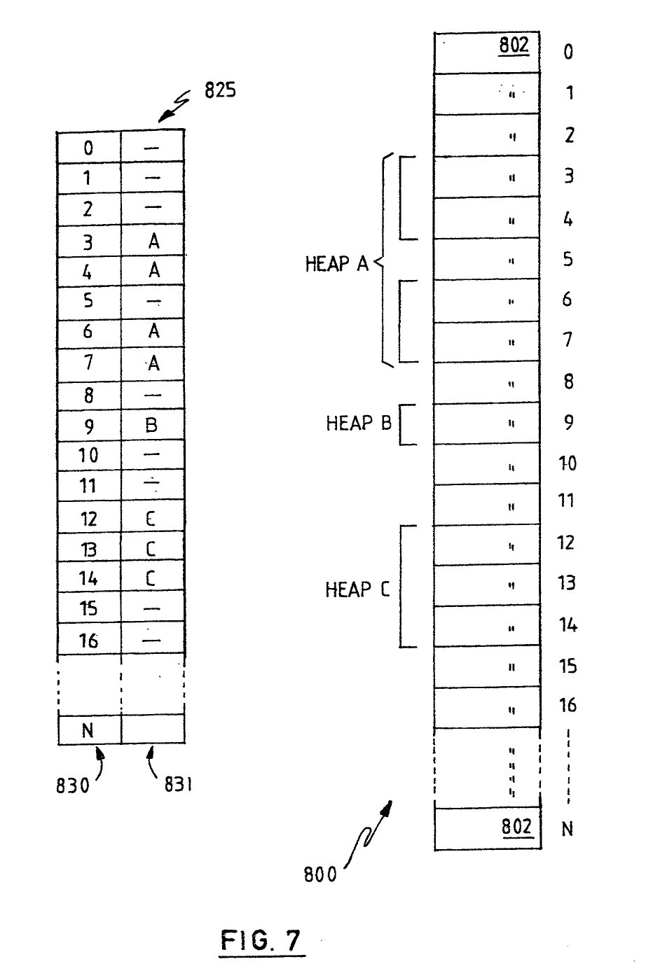

In order to overcome this problem, the preferred embodiment adopts the approach illustrated schematically in FIG. 7. As shown, system address space or virtual memory 800 is split into chunks of a standard size, referred to herein as slices 802. As previously mentioned, in the preferred embodiment on a 32 bit system, these slices are each 64 KBytes in size. The slices can be numbered linearly as shown with increasing address space. The heaps can then be allocated out of these slices, in such a way that heap space is always allocated or deallocated in terms of an integral number of slices. FIG. 7 shows three different heaps (for simplicity termed A , B and C) whereby heap A is non-contiguous and comprises slices 3-4 and 6-7, heap B comprises slice 9, and heap C is contiguous and comprises slices 12-14 inclusive. Note that two or more of these heaps may possibly be being managed as single block of storage (ie in the same manner to the transient and middleware heaps of FIG. 5).

Also illustrated in FIG. 7 is lookup table 825, which has two columns, the first 830 representing slice number, and the second 831 representing heap number. Thus each row of the table can be used to determine, for the relevant slice, which heap it is in—a value of zero (indicated by a dash) is assumed to indicate that the slice is not currently in a heap. The system updates table 825 whenever slices are allocated to or deallocated from the heap.

Using table 825 it now becomes very quick to determine whether a given memory address is in a heap. Thus an initial determination is made of the relevant slice, by dividing the given memory location (minus the system base memory location if non-zero) by the slice size, and rounding down to the next integer (ie truncating) to obtain the slice number. This can then be used to directly access the corresponding heap identifier in column 831. In fact, it will be appreciated that column 830 of Table 825 does not need to be stored explicitly, since the memory location of each entry in column 831 is simply a linear function of slice number. More specifically, each entry in column 831 can typically be represented by 1 byte, and so the information for slice N can be found at the base location for table 825, plus N bytes. Overall therefore, this approach provides a rapid mapping from object location to heap identity (if any), irrespective of the number of heaps, or the complexity of their configuration.

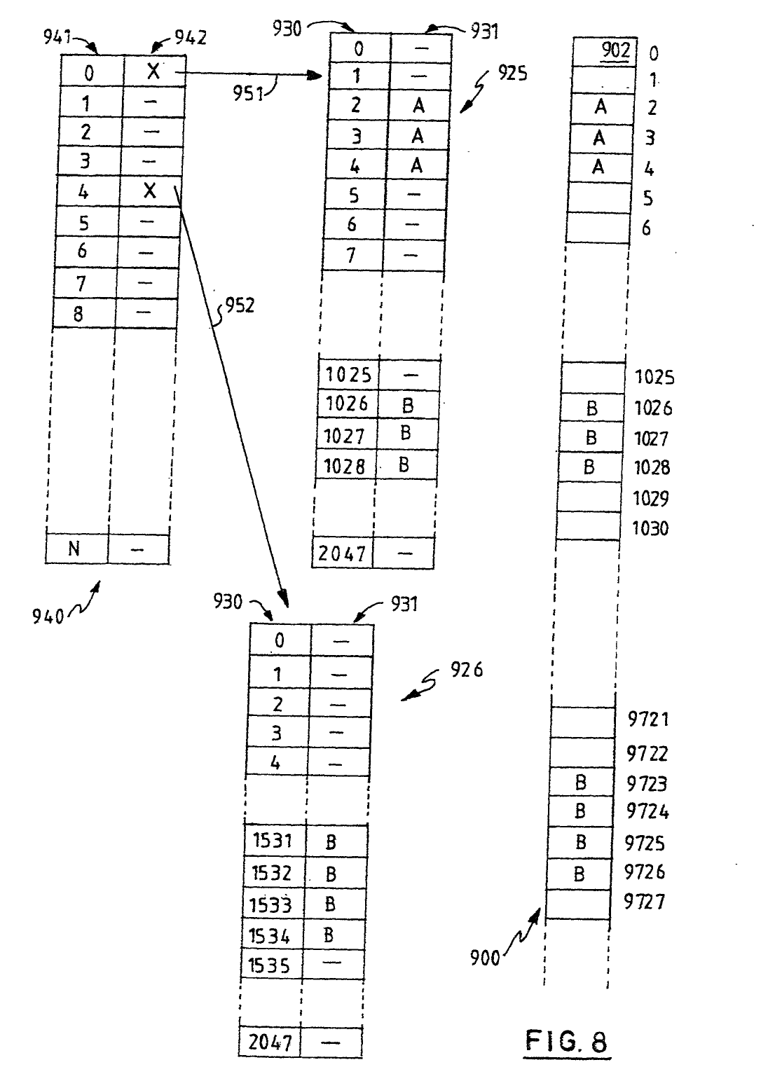

One problem however with the technique illustrated in FIG. 7 is that on 64 bit machines, the virtual memory or address space is so great that table 825 would become prohibitively large. Thus in a preferred embodiment for such systems, a modified mapping is used, as shown in FIG. 8, which has an extra layer in the memory mapping arrangement. In the diagram, memory 900 represents the system address space or virtual memory, which as in FIG. 7 is divided into slices 902 (the difference from FIG. 7 being that on a 64 bit system, address space is much larger, so there are many more slices). FIG. 8 illustrates the location of two heaps, arbitrarily denoted A and B, with A comprising slices 2-4 inclusive, and B comprising slices 1026-1028 inclusive and also slices 9723-9726 inclusive.

Also shown in FIG. 8 are two lookup tables, 925, 926, each of which, for the sake of illustration, contains 2048 entries, and maps to a corresponding range of slices in address space 900. Thus lookup table 925 maps slices 0-2047, whilst lookup table 926 maps slices 8192-10239. These lookup tables are directly analogous to that of FIG. 7, in that they logically contain two columns, the first 930 identifying a slice number, and the second 931 the identity of any heap within that slice (or else zero). Tables 925 and 926 can be regarded as forming the lower level of the lookup hierarchy.

FIG. 8 also depicts a higher layer in the lookup hierarchy, namely table 940, which again logically contains two columns. The first column 941 logically represents the number of lookup table 925, 926 in the next lower layer of the lookup hierarchy, whilst the second column 942 contains a pointer to the relevant lookup table. Thus the first row of column 942 contains a pointer 951 to table 925, and the fifth row of column 942 contains a pointer 952 to table 926.

It will be noted that to conserve space, lookup tables in the lower level of the hierarchy only exist where at least some of the corresponding slices are assigned to a heap. Thus for the particular arrangement of FIG. 8, the lookup tables for slices 2048-4095, 4096-6143, and 6144-8191 have not been created, since none of these slices has been assigned to any heap. In other words, lookup tables 925, 926, etc for various slice ranges will be created and deleted according to whether any slices within that slice range are being utilised for the heap. If this is not the case, and the lookup table is deleted (or not created in the first place), the pointer in column 942 of top level lookup table 940 is set to zero.

The operation of the embodiment shown in FIG. 8 is analogous to that of FIG. 7, except that there is an extra level of indirection involved in the hierarchy.

Thus to determine whether a particular reference or address is within a heap, the correct row is determined based on a knowledge of the size of a slice 902, and also the number of rows in each lower level lookup table 925, 926. It is expected that for most rows, the corresponding entry in column 942 will be null or zero, immediately indicating that that address is not in a heap slice. However, if the lookup selects a row which has a non-zero entry, this is then followed (using pointer 951, 952 or equivalent) to the corresponding lookup table. The desired entry is then found by locating the row using the reference under investigation (allowing for which particular lookup table is involved), and examining the entry for that row in column 931. This will indicate directly whether or not the slice containing the referenced location is in a heap, and if so, which one.

As an example of this, to investigate memory address 637405384 we first integer divide by 65536 (the size of a slice in the preferred embodiment), to give 9727 (truncated) , implying we are in slice 9727. Next we perform an integer division of 9727 by 2048 (the number of entries in each lower level look-up table), to give 4 (truncated), implying we are in the 5th row of column 941. It will be appreciated that we could have got here directly by dividing 637405384 by 134217728 (which equals 2048×65536, or in other words, the total number of addresses per lower level lookup table). In any event, from the 5th row of table 940, it is determined that the corresponding entry in column 941 is non-zero, so that the specified address may possibly lie in a heap. Accordingly, pointer 952 is followed to table 926. Here we can determine that the row of interest is number 1535 (equal to 9727 modulo 2048), from which we can see that this particular slice is not, after all, part of heap. It follows of course that this is also true for any address within this slice.

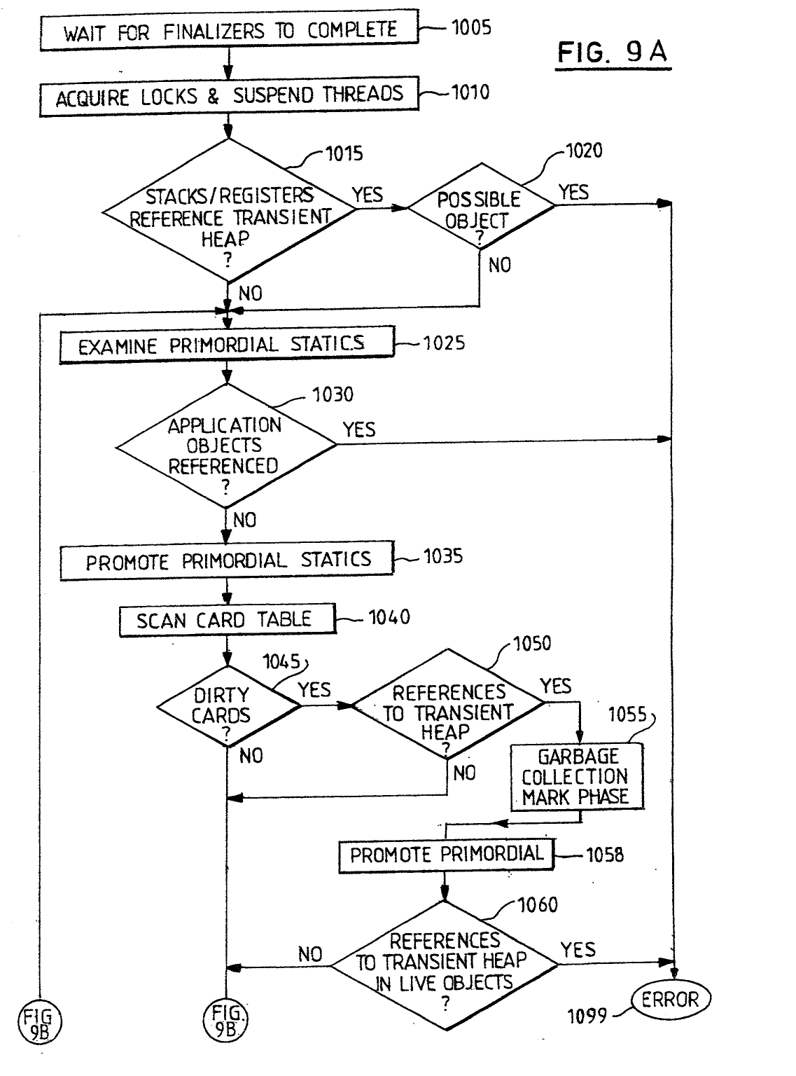

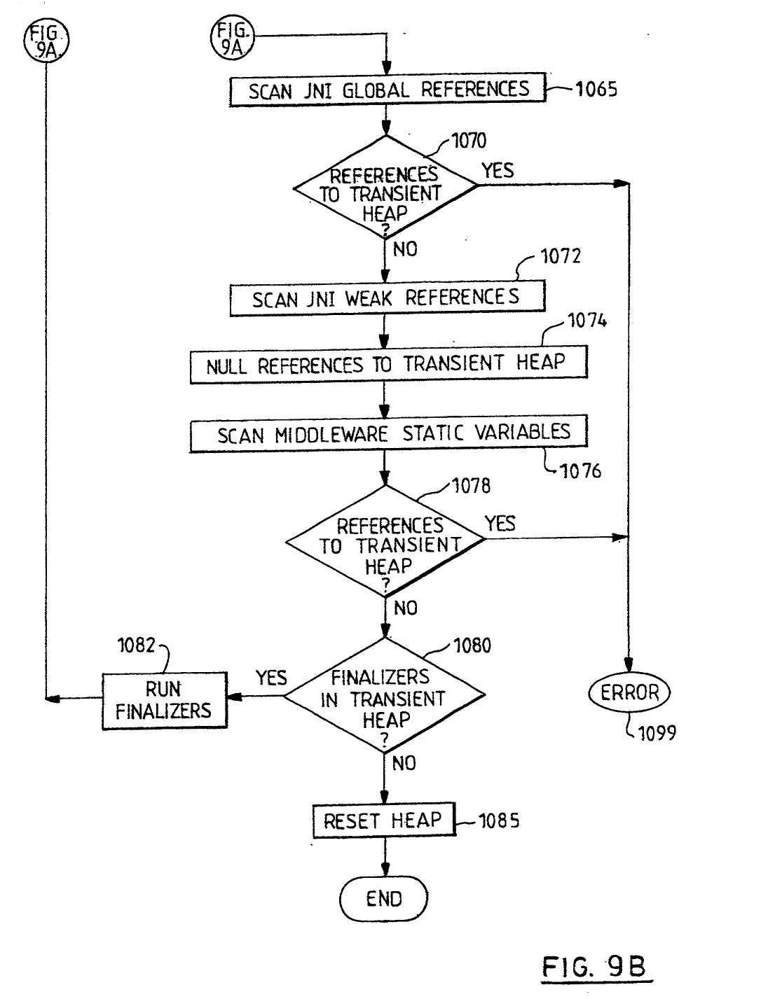

Returning now to FIG. 4, as previously described, at the end of a transaction the transient heap is deleted (equivalent to the refresh heap step 445, performed as part of the Reset JVM). This activity is generally similar to garbage collection, although certain optimizations are possible, and certain additional constraints need to be considered. This process is shown in more detail in the flow chart of FIG. 9 (which is split for convenience into two components, 9A and 9B).

The first step in FIG. 9A (1005) is to wait for all finalization activity to complete. Thus if there has been a GC during a transaction then there may be finalizers to be run and they must be run before the transient heap can be reset, as the finalizers could create (or require) other objects. This checking is performed by confirming that there are no object waiting for the finalizer thread, and that there are no other in-progress objects (ie the processing of all pending finalization objects has been completed). Next all the locks required for garbage collection are obtained, and all other threads are suspended (step 1010). The system is now in a position to commence deletion of the transient heap.

In order to accomplish this, the stacks and registers of all threads are scanned (as for a normal garbage collection), and if a reference is found to the transient heap (step 1015) then the Java VM is potentially dirty and so cannot be reset. The reason for this as discussed in relation to standard garbage collection (FIG. 6) is that the references on the stacks and registers must be treated as live, even though it is not certain that they are in fact object references. To firm up on this the references are tested to see if it is possible to exclude them from being object references (step 1020), essentially by using the same three tests 612, 615 and 620 of FIG. 6. In other words, if the possible reference is not on the heap, or does not fall on an 8-byte boundary, or does not correspond to an allocated memory location, then it cannot in fact be a reference. Otherwise, the register or stack value may still be a reference, and so processing has to exit with an error that the Java VM is dirty and cannot be reset (step 1099). Note that references from the stacks or registers to the middleware or system heap are of course acceptable, because objects on these heaps are not being deleted.

It will be appreciated that based on the above, a spurious data value in a stack or register will sometimes prevent Java VM reset. However this happens relatively infrequently in practice, because all but the main application thread and certain system threads should have terminated at this point, so the stacks are relatively empty (nb the policy adopted in the preferred embodiment is that a Java VM cannot be reset if more than a single transaction thread was used; multiple middleware threads are tolerated providing they have terminated by the completion of the middleware tidyups). Related to this, as previously mentioned finalizer objects on the transient heap are retained in that heap until a Java VM reset. This means that references to such objects are not entered onto the stack for the finalizer thread, which would otherwise typically cause the reset to fail at steps 1015 and 1020 (this would be the case even where the finalize method for the object had been finished, since this would not necessarily lead to complete deletion of the corresponding stack entry; rather the finalizer thread may enter a function to wait for more work, resulting in uninitialized areas on the stack which may point to previously processed finalizer objects).

It is important to note that error 1099 indicating that the Java VM is dirty does not imply that previous processing was incorrect, merely that the Java VM cannot be reset (although of course this may in turn indicate some unexpected action by the application). In other words, a new Java VM will need to be created for the next application. Because of this, if it is detected that the Java VM is dirty, such as a negative outcome at step 1020, the method normally proceeds immediately to step 1099. This returns an error code to the Reset JVM request from the middleware, with no attempt to continue to perform any further garbage collection. The reason for this is that the middleware may want to do a little more tidying up, but generally it is expected that it will terminate the current Java VM fairly quickly. Hence there is unlikely to be a need for any further garbage collection, which rather would represent an unnecessary waste of time. A similar policy is adopted whenever the processing of FIG. 9A indicates that the Java VM is dirty.

Assuming now a negative result from step 1015 or 1020, the Java VM refresh continues with an examination of the primordial statics fields (step 1025) to see what objects they reference. Since these fields will be retained through the Java VM reset, it is important that the objects that they reference, either directly or indirectly, are likewise retained. If however the referenced objects are application objects (tested at step 1030) then clearly these cannot be retained, because the application has essentially terminated, and the purpose of resetting the Java VM is to allow a new application to commence. Therefore, if the primordial statics do reference an application object, then the Java VM is marked as dirty, and the method proceeds to error 1099.

Assuming that the objects referenced by the primordial static fields are not application objects (typically they will be primordial object instances or arrays), then these are moved (“promoted”) from the transient heap to the middleware heap (step 1035). The reason why such objects are placed on the transient heap initially is that at allocation time, it may not be known that the object to be allocated is a primordial static variable, or reachable from one.

(Note that this approach bears some similarities to generational garbage collection, in which new objects are initially allocated to a short-term heap, and then promoted to a longer-term heap if they survive beyond a certain time, but the criterion for promotion is different: essentially it is based on object type or usage, rather than age. Generational garbage collection is discussed further in the book by Jones and Lin referenced above).

After the primordial static objects have been promoted, the next step is to review the card table (536—see FIG. 5). The card table represents a set of bytes, one per fixed unit of heap (for example 512 bytes). Whenever an object reference is written to the heap, the card table is updated to indicate dirty (nb marking a card as dirty does not imply that the Java VM itself is necessarily dirty). The card updated corresponds not to the portion of the heap which contains the updated object reference itself, but rather to the portion of heap which contains the top of the object that includes the reference (for a small object these may of course be the same). Given that updating object references is a frequent operation, the card table must operate very quickly. This is the reason why each card is a byte despite containing only a single bit of information, because in practice this can be manipulated more quickly. Furthermore, no attempt at this write stage is made to investigate the nature of the reference update, for example whether the reference was set to a null value, or to an object in a particular heap.

Now during Java VM reset the card table is scanned, or more particularly those cards which correspond to the region currently assigned to the middleware heap are scanned. Thus cards for the transient heap 520 and for the unassigned region 510 are not scanned, even if they have previously been part of the middleware heap. As part of this review, it is first determined whether any cards are set (ie marked as dirty) (step 1045). This indicates that a reference in the corresponding portion of the middleware heap has been updated since the last Java VM reset, and so must be checked to confirm that it does not point to the transient heap. The first part of this check is to find all object references in objects which start in the heap portion corresponding to the marked card. Note that there may be more than one object to review here, or possibly none at all if the object previously located there has since been garbage collected and the space reused by a larger object whose beginning is situated outside that portion of the heap. For all objects associated with a marked card, all references contained in those objects (even if the references themselves are outside the portion of the heap corresponding to the card) are checked to see if they point to the transient heap (step 1050). If they do not, for example they contain only null pointers, and/or references to the middleware heap, then this is not a problem for Java VM reset. On the other hand, if there are any such pointers to the transient heap from the middleware heap, this will be a problem on reset since those references will no longer be valid once the transient heap is cleared. The exceptions to this are where the objects containing these problematic references are no longer live (ie could be garbage collected), or are primordial and can be successfully promoted.

Note that in step 1050 there is no need to perform tests analogous to step 1020 to see if the address does correspond to an object (such as being on an 8-byte boundary, etc). This is because the scan card process uses the known class structure of an object to specifically pick out any object references therein, rather than simply looking for a possible address that corresponds to the transient heap.

On a positive outcome to step 1050, and indeed immediately a single such reference is found (because this is enough to potentially prevent reset) the system performs the mark phase of a garbage collection (step 1055), which is a relatively long operation. The purpose of this garbage collection is that if the problematic (cross-heap) references are in objects which are marked (ie live), as tested at step 1060, then the JVM must be regarded as dirty; hence the method proceeds to error 1099. On the other hand, if the problematic references are in objects which are not marked, then these references can effectively be ignored, since these objects are no longer live.

A further possibility as mentioned above is that the reference is actually to a primordial object which can be promoted into the middleware heap. This processing is shown as step 1058 in FIG. 9, is largely analogous to step 1035 (which only promoted a limited subset of primordial objects, namely those referenced by primordial statics). Any such promoted objects also now need to be checked for any pointers back to the transient heap. In some situations this can lead to a chain of primordial objects being promoted from the transient heap back up to the middleware heap. (Note that although step 1058 is shown separately from the GC mark phase in step 1055 in FIG. 9A, they are actually performed together in the preferred implementation.

One complication that may occur is that the heaps may have been compacted during a transaction, as previously described in relation to garbage collection. This then invalidates the card table. In such cases a full scan of the middleware heap is then performed automatically to locate any object references to the transient heap, equivalent to the garbage collection mark phase of step 1055.

Assuming that the test of step 1060 produces a negative output (ie no live middleware references to the transient heap), the method proceeds to scan JNI global references. These are references which are used by native code routines (ie running directly on OS 30 rather than on Java VM 40, see FIG. 1) to refer to Java objects. Using the Java Native Interface (JNI) such references can be made global, that is available to all threads, in which case they will exist independently of the thread that created them. All such JNI global reference slots are scanned (step 1065) (see FIG. 9B) and if a reference to the transient heap is found (step 1070) the Java VM is marked as dirty (ie error 1099), since these references will clearly fail once the transient heap is reset.

Providing this is not the case, the JNI weak references are scanned next (step 1072). These are references which the application specifies using JNI as expendable, in that they can be deleted if no longer used. According, any such weak JNI references to the transient heap that are found can be nulled (step 1074), thereby permitting the Java VM reset to proceed.

Next, the static variables of all middleware classes are scanned (step 1076) to see if any directly reference the transient heap (step 1078). Note that these won't previously have been examined, since they are on the system heap rather than the middleware heap. If a direct reference to the transient heap is found, the Java VM is dirty, corresponding to error 1099. (Note that unlike for the primordial statics (step 1025) there is no need to iteratively follow references from the middleware statics, since any indirect references will already have been picked up by preceding analysis). If no transient heap references are found, the processing continues to step 1080 in which objects on the transient heap are reviewed to see if any have finalizer methods, and any that are found are now run (step 1082). One important aspect of the preferred embodiment is that these finalizer methods are run on the main thread, rather than being passed to the system finalizer thread. An implication of this is that the finalizer methods will be run in the known and controllable context of the main thread. In addition, it is ensured that the finalizer methods complete before progressing to the next stage of the Java VM reset. Unfortunately, finalizer methods can create fresh objects, which may newly reference the transient heap. Therefore, after the finalizer methods have completed, processing must return to step 1025 to repeat much of the checking, to ensure that the system is still in a position for Java VM reset. In theory, if the finalizer methods have created new objects on the transient heap which themselves have finalizer methods, then this loop may have to be followed more than once.

Note that strictly speaking there is no formal requirement to run the finalizers at this stage, since this is the point at which the Java VM would normally terminate at the conclusion of an application, rather than having a garbage collection performed. Nevertheless, the policy in the preferred embodiment is that object finalizers will be run before deletion at JVM reset, although other implementations may have different policies.

It is assumed that eventually all finalizers will be run, resulting in a negative outcome to the test of step 1080. In these circumstances, the method proceeds to step 1085, which represents reset of the Java VM by deleting the transient heap. In practice, this involves several operations. Firstly, if the mark phase of the garbage collection was run (step 1055) then the sweep phase, which is relatively quick, is now run on the middleware heap. Next, various operations are performed to formally reset the transient heap, including: the removal of all transient heap monitors and the freeing of storage for transient heap class blocks (ie releasing the storage utilised by the class block, which is not on the heap). The transient heap pointers can now be reset so that the heap is effectively emptied, and restored to its initial size (by setting boundary 522 appropriately).

Once the transient heap has been recreated (although it could be done before), in the preferred embodiment a garbage collection is performed on the middleware heap if either of the following two cases is true: firstly, if the number of slices left in the unallocated portion of the heap, between the middleware heap and the transient heap, is less than two, or secondly if the amount of free space in the middleware heap plus half the unassigned portion 515 of the heap (see FIG. 5) is less than the amount of storage used by the previous transaction times three. Both of these can be regarded as a preemptive garbage collection, performing this operation now if the next transaction is otherwise likely to be constrained for space, in the hope that this will avoid a garbage collection during the transaction itself. Note that in the current implementation this preemptive garbage collection would be performed irrespective of whether a garbage collection mark phase was performed in step 1055. Finally, all the threads can be restarted and the garbage collection locks released, whereupon the reset is completed, and the Java VM is available to support the next application.

It will be appreciated from the foregoing that the presence of cross-heap pointers is a key element in the performance of the resettable Java VM. This is because if any cross-heap pointers are located at reset (step 1050 in FIG. 9A), then a time-consuming garbage collection is required (step 1055 in FIG. 9A) to try to confirm that such pointers are all in dead objects. However, if this turns out not to be the case, in other words at least one of the cross-heap pointers is in a live object (step 1060 in FIG. 9A), then the reset cannot be performed at all.

Note that for present purposes a cross-heap pointer will be taken as only representing pointers from the middleware heap into the transient heap, not vice versa.

In fact, this is something of a simplification, since as previously mentioned in the preferred embodiment there are additional heap components (the system heap and application shared heap) which like the middleware heap are not deleted at reset. To be strictly accurate therefore a cross-heap pointer represents any pointer from a component of the heap which is not being reset into the component of the heap which is being reset (the transient heap).

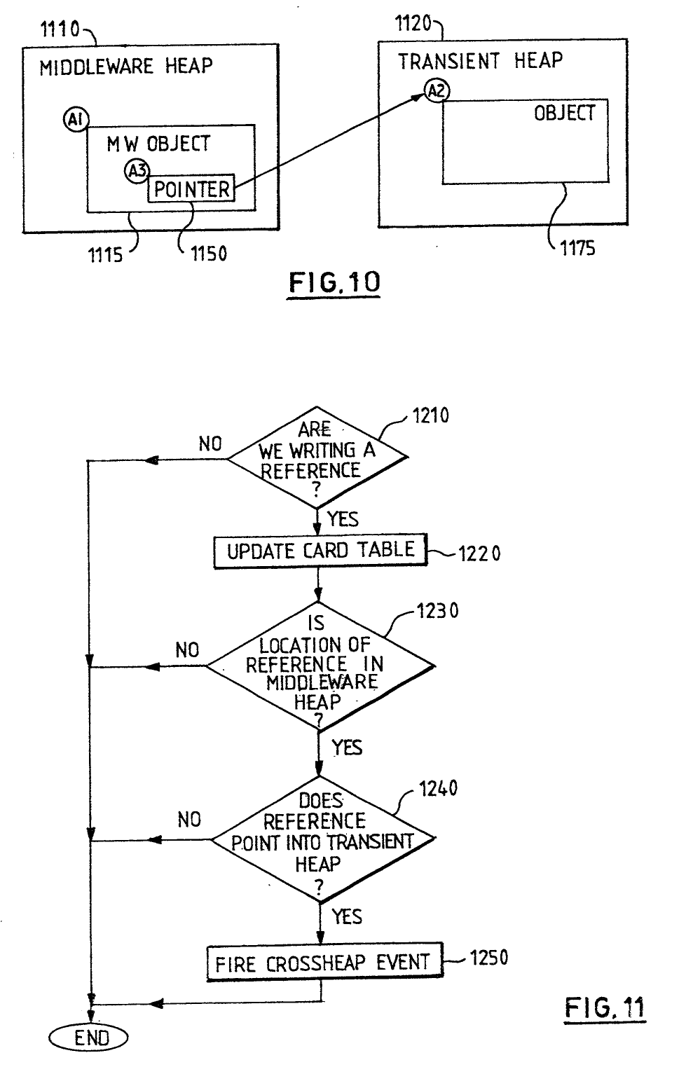

FIG. 10 illustrates an example of a cross-heap pointer, and depicts the middleware heap 1110 and the transient heap 1120. The middleware heap, for illustrative purposes, contains a single middleware object 1115, which includes a field 1150 that points to an object 1125 in the transient heap. Pointer 1150 is therefore a crossheap pointer. For future reference, the (starting) address of the middleware object 1115 is denoted A1, the address of the pointer field 1150 in the middleware object is denoted A3, and the address of the object 1125 referenced by pointer 1150 is denoted A2 (in other words, pointer 1150 actually has the value A2).

It is clearly of particular importance for the application and middleware developer to be able to eliminate such cross-heap pointers if at all possible. However, in complex programs this is not always an easy task, especially since it only takes a single cross-heap pointer to trigger the full garbage collection at step 1050, and a single live cross-heap pointer to prevent reset altogether (ie make the Java VM unresettable). Unfortunately however, the information most readily available to a programmer at a failed reset is generally of limited assistance in understanding the cause and origin of a cross-heap pointer. In particular, at reset, the system has only the “from” address and the “to” address of the crossheap pointer (corresponding to A3 and A2 respectively in FIG. 10) to work with. Although the type of the referencing and referenced objects can be found, there is no indication available as to how these objects were created, or where the link should be broken to avoid prevention of reset.

Accordingly, a preferred embodiment of the invention supports the creation and firing of a set of events during the run of a transaction. These events can be written to a log and subsequently processed by a set of debugging tools in order to directly link any crossheap reference found at reset with the originating line of code in which the cross heap reference was created. In particular, the system makes use of the various pieces of information available at each event to track down the originating line of code.

There are actually two distinct types of potential crossheap references that need to be handled. The first arises from the situation mentioned earlier, in which a primordial object is created on the transient heap, and the crossheap reference is a link from an object on the middleware heap to such a primordial object. As previously noted, in this case the primordial object is copied or promoted from the transient heap to the middleware heap. All references to the promoted object are then adjusted accordingly, and will no longer represent crossheap pointers, since the referenced object is now within the middleware heap.

The second type of crossheap pointer is a reference to an application object in the transient heap from an object in the middleware heap. As discussed above, if it remains live such a link must cause the Java VM reset to fail, since the application classes are all destroyed at reset.

In order to track the different types of crossheap pointers a special set of events are defined. The utilisation of these depends on the mode of operation of the Java VM. Thus in the preferred embodiment two modes of operation are supported: production and debug. In production mode, which represents conventional, productive use of a system, performance is highly significant, and so it is desirable to try to limit the number of events fired. Conversely, in debug mode, which represents development use of a system, the main focus is on helping a programmer to understand the behaviour of the system, and so more events can be fired to assist diagnostics, even if this degrades performance.

The following are the main events supported to assist a developer in handling crossheap pointers:

(1) Unresettable event (URE)—this operates in both debug and production mode, and is fired at reset when any live reference from a middleware heap object to an application object is found (one event is fired for each such reference found). This would cause the reset to terminate, and corresponds essentially to step 1060 in FIG. 9A. At firing of this event, the pieces of information available for recording with the event are the address of the object in the transient heap (A2), and the address in the middleware heap (A3) which references it (typically a field in an object). In theory the address (A1) of the object in the middleware heap that contains the cross-heap reference could also be derived; however, in the current implementation it is not obtained for performance reasons.

2) ResetTrace event (RTE)—this event is fired if a reference from the middleware heap into the transient heap is found at reset (corresponding to a positive outcome to the test at step 1050). In production mode only a single such event is generated, because as soon as one such reference is found the method proceeds into the garbage collection mark phase. However, in debug mode the system finds all such references in step 1050, and a separate event is generated for each such link located. Although RTEs do not in themselves prevent resetting the Java VM, they indicate an adverse performance effect in which a garbage collection mark phase is initiated to see if the reference (or more accurately the object containing it) is still live. Avoiding this trace makes the reset perform better, so it is desirable to eliminate ResetTrace events.

For an RTE, the identity of the originating object (A1), the reference to the transient object (A3), and the address of the transient object (A2) are available for capture. Unlike for a URE, the address of the originating object (A1) is relatively easily accessible here because the scan card process that looks for dirty cards including references to the transient heap specifically identifies each object in a dirty card (as previously described in relation to FIG. 9).

3) Promotion event (PE)—this event is used in debug mode only, and is fired if a primordial object is moved from the transient heap to the middleware heap at reset in step 1035 or in step 1058 in FIG. 9 as previously discussed.

At a promotion event, the system has available the address in the transient heap from which the object was moved, the address in the middleware heap to which it went, and the size of the object moved, and this is provided as part of the event record. In addition, the location of the cross-heap pointer (A3) that originally referenced the object being promoted is also recorded. Note that the promotion event is not utilised by the production system, since it would slow down the reset operation.

4) Crossheap event (CHE)—this event is fired in debug mode every time a middleware object references any address in the transient heap. The events are fired by a write barrier that is inserted in the path of all updates that occur to objects in the middleware heap. This is an expanded form of the write barrier that has already been discussed in relation to the card table (536 in FIG. 5), and is discussed in more detail below with reference to the flow chart of FIG. 11. For a CHE, the pieces of information available to the system are the address at which the reference is being stored in the middleware heap (A3), and the address (A2) of the object which is being referenced in the transient heap. These are captured in the event record, along with a stack dump representing the current state of the program. Note that the crossheap event is only fired in debug mode because it requires a more complicated write barrier than the simple card table update, and so would otherwise significantly degrade performance in the production environment.

Looking now at FIG. 11, this shows operation of the write barrier which is triggered by an update to the heap. The first step of this processing (step 1210) is a test to see whether or not the update involves writing an object reference into the heap. If not, some other piece of data (such as an integer field) that cannot represent a crossheap pointer is being stored, and consequently the method exits, since this is of no concern in the present situation. On the other hand, if the data being stored is indeed an object reference, then the card table is updated accordingly, in line with the processing previously described (step 1220). In production mode the processing would now terminate, but in debug mode the write barrier performs further processing in order to determine whether or not the reference being stored is a crossheap pointer. This basically involves checking that (i) the reference is being stored at a location in the middleware heap (step 1230); and (ii) that the reference points into the transient heap (step 1240). A Crossheap event is only fired (step 1250) if both these conditions are satisfied. Note that in order to determine in which heap a given memory address is located, the preferred embodiment utilises the lookup mechanism described above in relation to FIGS. 7 and 8.

Having generated the above set of events, during application flow and then at reset, it is necessary for an application developer to be able to make sense of them. The primary aim is to eliminate Unresettable events, which indicate that reset has failed completely, and also ResetTrace events, which indicate that the reset process has had to invoke a garbage collection, and so suffered a serious performance hit. In order to help achieve this, the objective is to link each Unresettable event and each ResetTrace event back to the corresponding Crossheap event which gave rise to it. Once this has been done, the stack dump for the Crossheap events can then help the developer understand the origin of the Unresettable and ResetTrace events, and hopefully modify the program so that they will not occur in the future.

In order to perform this mapping, there are various situations that need to be considered (it is assumed that the system is operating in debug mode in order to generate the full set of events):

(1) URE, RTE and CHE are found which all have the same “from” and “to” address (A3 and A2 respectively in FIG. 10). This is a straightforward situation in which the CHE indicates the formation of a cross-heap pointer, which on reset first causes a ResetTrace event as the pointer is detected at step 1050. Subsequently, the garbage collection fails to clear this pointer, and accordingly it causes a URE as reset fails at step 1060.

(2) A RTE and CHE are found which both have the same “from” and “to” address (A3 and A2 respectively in FIG. 10), but there is no URE (in other words, the reset eventually succeeded). Here the CHE indicates the formation of a cross-heap pointer, which on reset first causes a ResetTrace event as the pointer is detected at step 1050. However, the offending cross-heap pointer is then either deleted (not marked as live) during the garbage collection phase (step 1055 in FIG. 9), or else the object containing it is promoted (step 1058 in FIG. 9), both options thereby permitting the reset to continue. Note that the latter possibility can be distinguished by the presence of corresponding promotion events.

(3) A RTE and CHE are found which both have the same “from” and “to” address (A3 and A2 respectively in FIG. 10), but there is a URE which has a different address. In this case it is possible that the RTE and CHE were generated by references to an object which was then promoted during step 1058 (in FIG. 9) in order to eliminate the cross-heap pointer; it was then a reference from the promoted object that caused the URE. This scenario can be extended to cover a whole chain of object promotions. In other words, a first promoted object can reference a second object in the transient heap, which then is promoted but contains a reference to a third object in the transient heap, which is then promoted, and so on.

(4) A URE and RTE are found which both have the same “from” and “to” address (A3 and A2 respectively), but there is no corresponding CHE. This can occur when the object responsible for the CHE has been promoted in step 1035 due to being referenced from a primordial static (again this may lead to a whole chain of promotions).

(5) A URE, RTE and CHE are present but none match up in terms of the “from” and “to” address. This can arise from a combination of (3) and (4) above, with promotion events having occurred at both step 1035 and also step 1058 in FIG. 9.

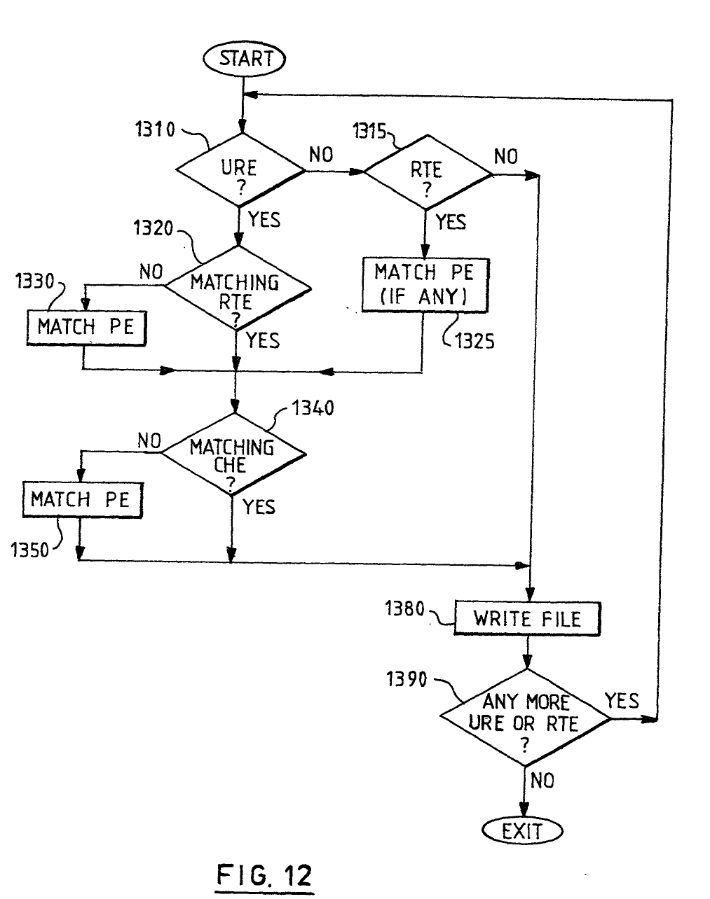

The processing associated with sorting an event log is shown in FIG. 12. In theory this processing could be performed manually, but in practice a large number of events are generated, and a tool has therefore been written to automate the sorting. Note that this can be performed either in real-time if desirable, as events are generated, or alternatively after the test application has completed.

The first step in FIG. 12 is to look for an Unresettable event (step 1310). Assuming that there is one, we then look for an ResetTraceEvent having a matching value for pointers A2 and A3 (step 1320). If this is not immediately successful, then we need to utilise the promotion events to make a match (step 1330). The handling of such promotion events is described in more detail below. Once the matching RTE has been identified, a search is made for the corresponding Crossheap event, in other words, having the same values for A2 and A3 as for the RTE (step 1340). If this is not found directly, then further promotion events must be investigated to link the RTE to the correct CHE (step 1350). Once this has been achieved, the sorting is effectively completed, and the URE, RTE and CHE, along with any relevant promotion events, can be written out to a log file (step 1380). Note that the information recorded with the CHE includes the stack dump reported by this event, which is useful for future debugging.

Returning now to step 1310, if there is no URE (ie the system reset properly), then a test is made to see if there are any RTEs (step 1315). If not, this can be recorded in the log file. On the other hand, if an RTE is found at step 1315, then it means that the reset processing successfully removed the cross-heap pointer, either by garbage collection or by promotion (or conceivably both). To investigate this further, step 1325 looks for promotion events related to the RTE; in other words, where the object referenced by the cross-heap pointer that generated the RTE is promoted, possibly along with further objects that this object itself references. If no such events are found, this means that it was the garbage collection that successfully removed the cross-heap pointer. The method now proceeds to step 1340, where the RTE is linked to its corresponding CHE as previously described, again matching to intervening promotion events if necessary. As before, the results are then written out to file at step 1380.

The final part of the method for event sorting is a test at step 1390 to see if all the URE and RTE events have been processed—if not, the process loops back to the beginning, otherwise it exits.

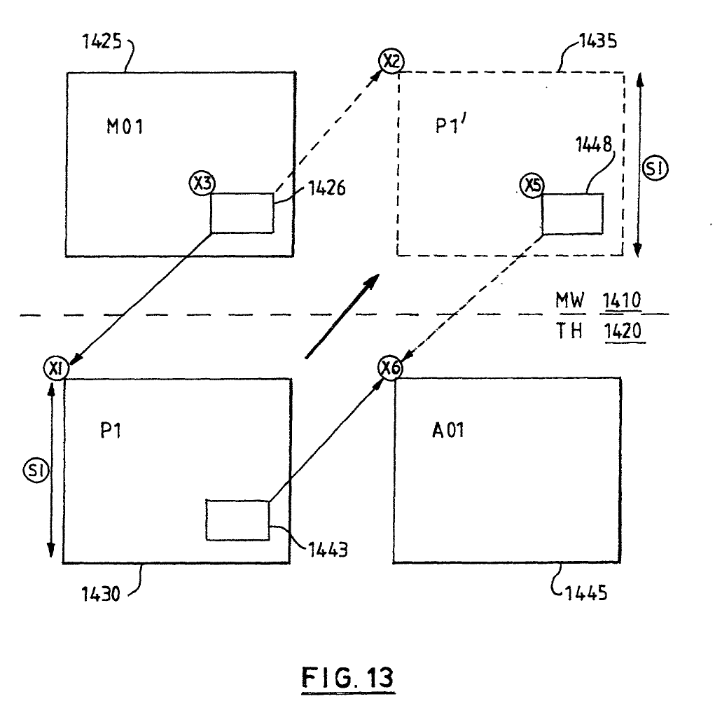

FIG. 13 illustrates the problem of matching a URE with a RTE, or a RTE with a CHE, in the presence of intervening promotion events. FIG. 13 shows the middleware portion 1410 and transient portion 1420 of the heap. The middleware heap includes an object MO1 1425 which includes a cross-heap pointer 1426 to a primordial object P1 1430. When pointer 1426 was initially set, a corresponding cross-heap event (CH1) must have been generated, which would store the from and to address of this pointer (ie the location X3 of pointer 1426, and the location X1 of primordial object 1430, this latter value of course being the value of pointer 1426).

Now in order to eliminate cross-heap pointer 1426, primordial object 1430 gets promoted into the middleware heap, where it is shown in dashed outline as P1′ 1435. As part of the promotion, pointer 1426 in the middleware object 1425 gets updated to point to the relocated primordial object P1′. This promotion causes a promotion event, which stores the original location of P1 (=X1) in the transient heap, the new location of P1′ in the middleware heap (=X2), the size of object P1 (=S1; this clearly also equals the size of P1′), and also the location (X3) of the cross-heap pointer 1426.

We now assume that object P1 further includes a pointer 1443 to another object, application object AO1 1445, also in the transient heap 1420. When object P1 is relocated as object P1′, pointer 1443 is accordingly moved likewise, to new location 1448, although its value is unchanged. Note that pointer 1448 is now a cross-heap pointer, although the system does not fire a CHE during such promotion.

For present purposes we assume that the promotion of P1 occurs in response to a ResetTrace event (RTE1), and that the detection of cross-heap pointer 1448 then causes a Unresettable event (URE1). This corresponds to scenario 3 above, in that it is easy to link CHE1 and RTE1 since they will both store X3 and X1. However, URE1 will store the location (X5) of pointer 1448 as its from address, and the location of AO1 (X6) as its to address, so that the link between URE1 and RTE1 is not immediately apparent.

In order to make this link, we assume that the pointer 1448 at X5 is in a promoted object, and hence there is no directly matching RTE. We therefore look for a promoted event containing X5. This is done by looking at the new object address and size for each promotion event, and seeing whether the from address (X5) lies within the promoted object. In mathematical terms, this requires: X2<X5<X2+S1.

Once we have found a promotion event having a suitable X2 and S1 we work back and determine the previous position of the object P1′ before it was promoted. We know from the information recorded in a promotion event that this previous position is X1. We now look to see if we can find a CHE (and RTE in this case) relating to the object in this old position. In particular, the “to” value of the CHE and RTE must match the old location of P1 (X1). Once we have found an RTE/CHE pair with such a value of X1, then we have successfully linked the URE back to its originating RTE/CHE, via the intervening promotion event.

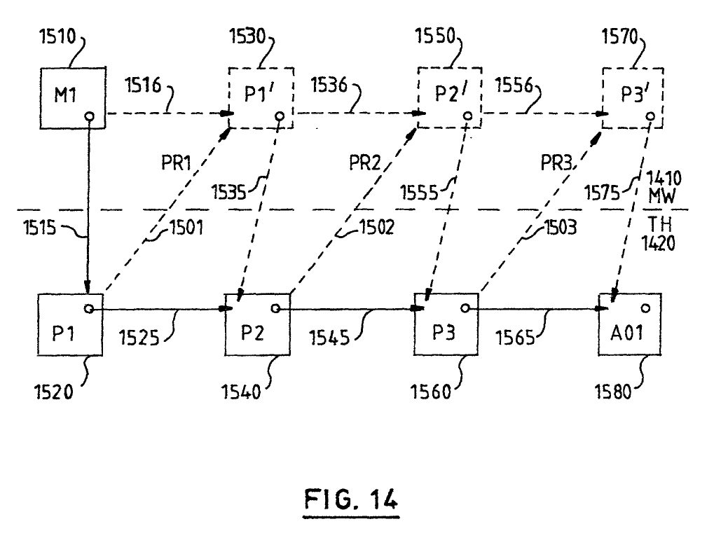

If a matching RTE is not found at this stage, then we must be dealing with a chain of promotions. This is illustrated in FIG. 14, where again we show the transient heap (TH) 1420 and the middleware heap (MH) 1410. The initial situation is where a middleware object M1 1510 includes a cross-heap pointer 1515 to primordial object P1 1520 in the transient heap, which will generate a ResetTrace event at step 1050 in FIG. 9A. In response to this cross-heap pointer, primordial object P1 is promoted to the middleware heap, shown as promotion PR1 1501. The new position of P1 is depicted as P1′ 1530. Pointer 1515 then has its value updated to reference P1′. This updated pointer 1516 is no longer a cross-heap pointer.

However, in FIG. 14, P1 itself includes a reference 1525 to second primordial object P2 1540. Therefore, in promoting P1, reference 1525 is moved to position 1535, within the middleware heap, but it retains its original value (ie “to” address). Accordingly, it now becomes a cross-heap pointer. The system detects this, and therefore promotes P2 also, via promotion PR2 1502, to its new position P2′ 1550 in the middleware heap. Pointer 1535 is then updated to a new value 1536 as appropriate.

However, this is not the end of the chain in FIG. 14, since object P2 is assumed to also have a reference 1545 to primordial object P3 1560, originally located in the transient heap. When P2 is promoted, reference 1545 is relocated correspondingly, and now becomes a cross-heap pointer 1555. This in turn leads to the promotion of P3 to become P3′ 1570, shown in FIG. 14 as PR3 1503, and pointer 1555 is updated to a new value 1556.

Unfortunately, in the example shown in FIG. 14, object P3 contains a reference 1565 to an application object 1580, which becomes a cross-heap pointer 1575 after the relocation of P3. Since it is not possible to promote application object AO1, cross-heap pointer 1575 will eventually cause the reset to fail, and so generate a URE.

We can track through the chain of promotions in FIG. 14 either forwards from the initial RTE, or backwards from the final URE. In the former approach, we start with the “from” address (A3) of pointer 1515, which is stored with the RTE, and look for a promotion event of an object that is triggered by a reference from this location. This should identify the promotion PR1. We can verify that this is correct, by comparing the “to” address of pointer 1515 (A2) with the starting position of P1 prior to promotion. This allows us to identify P1 as the promoted object.

We can then track from P1 to P2 by looking for a promotion event in which the referencing address, corresponding to the “from” address of pointer 1535, lies within P1′ (as determined by the new location and size of P1 as recorded for promotion PR1). Once the PE for PR2 has been found, the process can be repeated for PR3. In other words, the promoted position P2′ of P2 is found from the information recorded for PR2, and PR3 identified by having a referencing address 1555 within P2′. Finally the chain can be completed by matching to the URE, which stores the referencing address (A3) of pointer 1575, by determining that this address of pointer 1575 lies with the promoted position of P3 as recorded by PE PR3. In other words, this allows the full chain RTE, PR1, PR2, PR3, URE to be identified.

It is also possible to trace the chain of FIG. 14 in reverse, ie starting from the URE, back through PR3, PR2, and PR1 to the RTE, using essentially the same principles as described above. Thus commencing with the “from” address (A3) of the URE, we find a promoted event (PR3) where the position of the promoted object contains this address (as described in relation to FIG. 13). Next, using the “referenced from” information in PR3, we identify PR2 as the preceding promotion event, based on the fact that the promoted object (P2′) includes the “from” address of PR3. The analogous mechanism allows us to then identify PR1 as the promotion event immediately before PR2. Lastly, PR1 can be linked to the RTE as previously described in that they will both include the same “from” address, and in addition the “to” address in the RTE will correspond to the object position of P1 prior to its promotion at PR1.

Of course, whether searching forwards or backwards, the initial length of the chain is not known a priori. Therefore, when sorting the events, at any given point in the chain it is possible that the next event will either terminate the chain (eg a URE) or continue it (another PE). Consequently, when searching forwards from an RTE to a URE the process is to try to find a matching URE after adding each promotion event to the chain. Only if this is unsuccessful is an attempt made to add another promotion event to the chain. Similarly when searching backwards from a URE to an RTE, an attempt is first made to end the chain with an RTE, and if this is unsuccessful, another promotion event is looked for to add to the beginning of the chain.

In the preferred implementation, the searching is actually in a backwards direction, as shown in FIG. 12, in that the system looks for a URE initially, then a corresponding RTE, and if not found, one or more intervening PEs until the corresponding RTE is indeed found. The path can then be further traced back to the originating CHE. As a minor complication, the current implementation also allows ResetTraceEvents to be turned off, so that the system only generates Uresettable events, Promotion events, and Crossheap event. To support this, if the sort program is unable to link a URE to a RTE or a PE, then it will try to link to a CHE (via intevening PEs where necessary).

The tracing from an RTE to a URE shown in FIG. 14, via a series of promotion events generated at step 1058 in FIG. 9A, corresponds to the matching of step 1330 in FIG. 12. Exactly the same tracing mechanism can also be used to link a CHE with a RTE where the promotions occur due to a reference by a primordial static (step 1035 in FIG. 9A). This is used to implement step 1350 in FIG. 12. Note that such a reference by a primordial static must generate an initial Crossheap event because the primordial static itself will be stored in the relevant class file, not on the transient heap.

Although FIG. 14 shows a single complete chain, this need not always be the case. For example the chain may terminate early because a promoted object does not contain any references to objects on the transient heap, and so its promotion does not generate any cross-heap pointers that will cause a future RTE/URE. Such incomplete chains are most naturally traced in the forwards direction. The forward tracing of such a chain is shown in step 1325 in FIG. 14. (In the embodiment of FIG. 14 the forward tracing of promotion events from a Crossheap event that do not end up in a ResetTrace event is not performed, since this is regarded as a normal part of reset processing).

It is also conceivable that a chain of promotion events branches going forwards, if one promoted object contains references to multiple objects on the transient heap. Each such reference will in turn lead to either another promotion event or a Unresettable event (if tracing from a RTE). This branching will not affect tracing backwards along the chain, but will lead to multiple possible solutions going forward at the branch-point.

It should be noted that the event sorting process just described is not mathematically rigorous, in that it is possible to contrive peculiar event sequences which might not be correctly linked, for example by storing different objects successively at exactly the same address. However, in practice this is rarely found to be a problem, and the option of an analysis of individual objects by hand always remains.

An example of the log file produced by the sorting process in shown below:

[EVENT 0x1]
TIME=12/02/2001 at 13:21:44.264
THREAD=P=25548:O=0:CT (0:3e037be0)
CLASS=ResetTraceEvent
DESCRIPTION=0x4041B730 is an instance of
hursley/cassini/coordinator/_EJSRemoteCoordinator_Tie from
address 0x3E9BB158 within obj or array at 0x3E9BB130. 0x3E9BB130
is an instance of com/ibm/CORBA/iiop/RequestHolder
[END EVENT]
SORT: Corresponding cross heap event. . .
[EVENT 0x1]
TIME=12/02/2001 at 13:20:43.622
THREAD=P=25548:O=0:CT (0:3e037be0)
CLASS=CrossHeapReferenceEvent
DESCRIPTION=Transient or Shared heap object(0x40421B730) being
referenced in Middleware heap at 0x3E9BB158. 0x4041B730 is an
instance of hursley/cassini/coordinator/_EJSRemoteCoordinator_Tie
STACK=

at

com.ibm.CORBA.iiop.RequestHolder.target(RequestHolder.java:277)

at

com.ibm.rmi.corba.ServerDelegate.dispatch(ServerDelegate.java:280
)

at com.ibm.rmi.iiop.ORB.process(ORB.java:262)
at

com.ibm.rmi.iiop.IIOPConnection.doWork(IIOPConnection.java:1184)

at

com.ibm.cics.iiop.orb.CICSConnection.processRequest(CICSConnectio
n.java:329)

at

com.ibm.cics.iiop.RequestProcessor.processNormalMode(RequestProce
ssor.java:388)

at

com.ibm.cics.iiop.RequestProcessor.main(RequestProcessor.java:170
)

at java.lang.reflect.Method.invoke(Native Method)
at com.ibm.cics.server.Wrapper.call_main(Wrapper.java:413)
at com.ibm.cics.server.Wrapper.callUserClass(Wrapper.java:538)
at com.ibm.cics.server.Wrapper.main(Wrapper.java:819)

[END EVENT]

The match here is simple to perform in that the Crossheap event and the ResetTrace event have the same “from” address (0×3E9BB158) and the same “to” address (0×4041B730).

A second more complicated example of a sorted event trace is as follows:

[EVENT 0xd]
TIME=12/02/2001 at 13:21:43.662
THREAD=P=25548:O=0:CT (0:3e037be0)
CLASS=UnresettableEvent
DESCRIPTION=0x4038A350 is an instance of
hursley/cassini/utils/Test from address 0x3F1C51F0
[END EVENT]
SORT: No reset trace found, searching for promotions. . .
SORT: corresponding promotion event. . .
[EVENT 0x3]
TIME=12/02/2001 at 13:21:43.662
THREAD=P=25548:O=0:CT (0:3e037be0)
CLASS=PromotionEvent
DESCRIPTION=0x4034D740 in transient heap (length 0x20) promoted
to 0x3F1C51E8 - originally referenced from 0x3F1C3830
[END EVENT]
SORT: Corresponding promotion event. . .
[EVENT 0x3]
TIME=12/02/2001 at 13:21:43.650
THREAD=P=25548:O=0:CT (0:3e037be0)
CLASS=PromotionEvent
DESCRIPTION=0x403ACA28 in transient heap (length 0x4D0) promoted
to 0x3F1C3828 - originally referenced from 0x3F1BCBCC
[END EVENT]
SORT: Corresponding promotion event. . .
[EVENT 0x3]
TIME=12/02/2001 at 13:21:43.649
THREAD=P=25548:O=0:CT (0:3e037be0)
CLASS=PromotionEvent
DESCRIPTION=0x40372578 in transient heap (length 0x28) promoted
to 0x3F1BCBB8 - originally referenced from 0x3F1BCE28
[END EVENT]
SORT: Corresponding promotion event. . .
[EVENT 0x3]
TIME=12/02/2001 at 13:21:43.644
THREAD=P=25548:O=0:CT (0:3e037be0)
CLASS=PromotionEvent
DESCRIPTION=0x403725A0 in transient heap (length 0x20) promoted
to 0x3F1BCE10 - originally referenced from 0x3F1BCE64
[END EVENT]
SORT: Corresponding promotion event. . .
[EVENT 0x3]
TIME=12/02/2001 at 13:21:43.642
THREAD=P=25548:O=0:CT (0:3e037be0)
CLASS=PromotionEvent
DESCRIPTION=0x40373150 in transient heap (length 0x78) promoted
to 0x3F1BCE30 - originally referenced from 0x3F1BCF08
[END EVENT]
SORT: Corresponding promotion event. . .
[EVENT 0x3]
TIME=12/02/2001 at 13:21:43.641
THREAD=P=25548:O=0:CT (0:3e037be0)
CLASS=PromotionEvent
DESCRIPTION=0x40337C30 in transient heap (length 0x68) promoted
to 0x3F1BCEA8 - originally referenced from 0x3EFD6844
[END EVENT]
SORT: Corresponding cross heap event. . .
[EVENT 0x3]
TIME=12/02/2001 at 13:21:41.775
THREAD=P=25548:O=0:CT (0:3e037be0)
CLASS=CrossHeapReferenceEvent
DESCRIPTION=Transient or Shared heap object(0x40337C30) being
referenced in Middleware heap at 0x3EFD6844. 0x40337C30 is an
instance of com/ibm/rmi/corba/TypeCodeOutputStream
STACK=

at

com.ibm.rmi.corba.TypeCodeImpl.write_value(TypeCodeImpl.java:1855
)

at

com.ibm.rmi.corba.TypeCodeImpl.write_value(TypeCodeImpl.java:1840
)

at

com.ibm.rmi.iiop.CDROutputStream.write_TypeCode
(CDROutputStream.java:632)

at

com.ibm.rmi.iiop.CDROutputStream.write_any(CDROutputStream.java:6
15)

at com.ibm.rmi.javax.rmi.CORBA.Util.writeAny(Util.java:178)
at javax.rmi.CORBA.Util.writeAny(Util.java:71)
at

com.ibm.rmi.io.ValueHandlerImpl.write_Array(ValueHandlerImpl.java
:372)

at

com.ibm.rmi.io.ValueHandlerImpl.writeValueInternal(ValueHandlerIm
pl.java:137)

at

com.ibm.rmi.io.ValueHandlerImpl.writeValue(ValueHandlerImpl.java:
95)

at

com.ibm.rmi.iiop.CDROutputStream.write_value
(CDROutputStream.java:1024)

at

com.ibm.rmi.iiop.CDROutputStream.write_value
(CDROutputStream.java:716)

at

com.ibm.rmi.io.IIOPOutputStream.outputClassFields(IIOPOutputStrea
m.java:615)

at

com.ibm.rmi.io.IIOPOutputStream.defaultWriteObjectDelegate(IIOPOu
tputStream.java:159)

at

com.ibm.rmi.io.IIOPOutputStream.outputObject(IIOPOutputStream.jav
a:478)

at

com.ibm.rmi.io.IIOPOutputStream.simpleWriteObject(IIOPOutputStrea
m.java:121)

at

com.ibm.rmi.io.ValueHandlerImpl.writeValueInternal(ValueHandlerIm
pl.java:139)

at

com.ibm.rmi.io.ValueHandlerImpl.writeValue(ValueHandlerImpl.java:
95)

at

com.ibm.rmi.iiop.CDROutputStream.write_value
(CDROutputStream.java:1173)

at

com.ibm.rmi.iiop.CDROutputStream.write_value
(CDROutputStream.java:716)

at

hursley.cassini.coordinator._EJSRemoteCoordinator_Tie._invoke(_EJ
SRemoteCoordinator_Tie.java:179)

. . .More stack frames not shown

[END EVENT]

In this example there is an initial Unresettable event followed by a chain of 6 Promotion events, followed by the original cross-heap event (n.b. ResetTrace events were turned off for this log).

As a further refinement of the event manipulation process, it is found in practice that the same line of code can often be responsible for multiple cross-heap pointers, and so generate many event chains. To simplify matters for the programmer therefore, once the event chains have been constructed, they are filtered. Multiple event chains having the same stack dump (ie resulting from the same code location) are deleted in favour of presenting the programmer with just a single example, plus a count of the number of times it has occurred.

Based on the facility described herein in relation to cross-heap pointers, the application development cycle will typically be as follows. Code is run in production (release) mode to investigate if reset is being prevented (ie the presence of Unresettable events). If this is not the case, then the system is already working well and the application is sound (ie no cross-heap pointers). On the other hand, if Unresettable events are found, then these must be removed. The presence of a ResetTrace event can further be investigated, but these need attention only if reset performance is an issue.

Assuming that there are at least some cross-heap pointers to be investigated, the developer will then run the program in debug mode to generate a full listing of UREs, PEs, RTEs and CHEs. These will then be sorted and filtered as described above. This will provide the programmer with knowledge of exactly where in the application the problematic cross-heap references are being produced. With this information, the developer can then take steps to remedy the situation, for example by explicitly zeroing or nulling out the reference when its use is finished (rather than leaving it as a cross-heap pointer), or changing the middleware or application logic to avoid the problem altogether.

It should be noted that there are a couple of limitations in the current implementation of the above debug tools. The first one is that it is not possible to use JIT code, since in this case the necessary information for debugging is not available. However, this limitation can easily be avoided by disabling the JIT compiler when in debug mode (this is a standard option). An alternative would be to modify the JIT compiler itself to support the write barrier illustrated in FIG. 11, in which case this limitation could be avoided.

Secondly, it was mentioned in relation to garbage collection that if the heap becomes too fragmented, then it may be necessary to compact the heap together (this is step 675 in FIG. 6B). Since this involves moving objects from one location to another, the information collected in the crossheap events becomes invalid. This problem can be overcome by typically setting the Java VM to avoid compaction during a transaction (and increasing the heap size if necessary). It is strongly desirable anyway to generally avoid compaction, since it is very slow.

Although one preferred embodiment of the invention has been described in detail above, the skilled person will be aware of many possible variations this embodiment. For example, although the cross-heap pointer instrumentation has been described as operating primarily in debug mode only, it will be appreciated that in some systems the performance considerations may be such as to allow it to be used also in production mode. In addition, although a particular heap structure has been described, the invention has broad applicability to any heap arrangement having two or more heaps, in which a heap is to be deleted at a predetermined time, thereby precluding the presence of cross-heap pointers into this heap at deletion time. Note that the two heaps may simply be different logical sections of a single heap; there may be many heaps, some for example providing local storage for particular threads, etc.

In addition, while the invention has been described primarily in relation to Java in a server environment, it will be understood that it also applies to other languages and environments. As just one example, the problem of crossheap pointers also arises in the generational GC scheme mentioned earlier, and this could potentially benefit from the improved debug facility for crossheap pointers as provided by the present invention.

In summary therefore, many of the details of the systems and processes discussed above are exemplary only, and can be varied according to particular circumstances. Thus other modifications to the embodiments described herein will be apparent to the skilled person yet remain within the scope of the invention as set out in the attached claims.

1. A computer system for running one or more programs and including a memory having at least a first heap and a second heap in which objects are stored, wherein a first object is stored on said first heap, said system further including:
a write barrier for detecting that said first object has been updated by a program to include a first reference to a memory location in said second heap, said write barrier including means for outputting a cross-heap event specifying information about said first reference and the current state of said program; and
a reset facility for the second heap whereby all objects stored within the second heap are deleted, said reset facility including means responsive to the detection of a second reference from the first heap to the second heap for outputting a reset event specifying information about said second reference, wherein the information in said reset event can be combined with the information in said cross-heap event to determine if said first reference matches said second reference.

2. The computer system of claim 1 wherein the information in the cross-heap event about said first reference comprises the address of the first reference in the first heap, and the address of an object in the second heap to which the first reference points.

3. The computer system of claim 1, wherein the information in the cross-heap event about the current state of the program includes a stack dump.

4. The computer system of claim 2, wherein the information in the reset event about said second reference comprises the address of the second reference in the first heap, and the address of an object in the second heap to which the first reference points.

5. The computer system of claim 4, in which said first reference matches said second reference if (a) the address of the first reference in the first heap equal the address of the second reference in the first heap; and (b) the object in the second heap to which the first reference points is the same as the object in the second heap to which the second reference points.

6. The computer system of claim 1, in which the reset facility is responsive to the detection of a cross-heap reference from the first heap to the second heap to prevent deletion of the second heap.

7. The computer system of claim 6, wherein the reset event output in response to the detection of the second reference further indicates that the second reference has prevented deletion of the second heap.

8. The computer system of claim 6, in which the reset facility is responsive to the detection of the cross-heap reference to make an attempt to eliminate cross-heap references, and deletion of the second heap is only prevented if said attempt is unsuccessful.

9. The computer system of claim 8, wherein said attempt potentially involves promoting one or more objects from the second heap to the first heap to eliminate cross-heap references, and said reset facility is responsive to an object promotion to output a promotion event specifying information about an object before and after it is promoted.

10. The computer system of claim 8, in which said reset facility outputs a reset event termed a ResetTrace event in response to the detection of said second reference prior to the attempt to eliminate cross-heap references.

11. The computer system of claim 8, wherein said reset facility outputs a reset event termed an Unresettable event in response to the detection of a third reference from the first heap to the second heap, said Unresettable event specifying information about said third reference.

12. The computer system of claim 11, wherein the information in said Unresettable event can be combined with the information in said cross-heap event to determine if said third reference matches said first reference, and with information in said ResetTrace event to determine if said third reference matches said second reference.

13. The computer system of claim 9, wherein the information output about an object before and after it is promoted allows the first reference to be matched to the second reference via a chain of one or more intervening promotion events.

14. The computer system of claim 9, wherein the first reference is matched to the second reference via a promotion event if the first reference is to a promotion object before promotion, and said second reference is from said promotion object after promotion.

15. The computer system of claim 1, further including a tool to perform matching of said first and second references.

16. A method of operating a computer system for running one or more programs and including a memory having at least a first heap and a second heap in which objects are stored, wherein a first object is stored on said first heap, said method including the steps of:
detecting that said first object has been updated by a program to include a first reference to a memory location in said second heap,
outputting in response to such detection a cross-heap event specifying information about said first reference and the current state of said program;
providing a facility for resetting for the second heap whereby all objects stored within the second heap are deleted;
detecting as part of the resetting a second reference from the first heap to the second heap; and
outputting in response to such detection a reset event specifying information about said second reference;
wherein the information in said reset event can be combined with the information in said cross-heap event to determine if said first reference matches said second reference.

17. The method of claim 16 wherein the information in the cross-heap event about said first reference comprises the address of the first reference in the first heap, and the address of an object in the second heap to which the first reference points.

18. The method of claim 16, wherein the information in the cross-heap event about the current state of the program includes a stack dump.

19. The method of claim 17, wherein the information in the reset event about said second reference comprises the address of the second reference in the first heap, and the address of an object in the second heap to which the first reference points.

20. The method of claim 19, in which said first reference matches said second reference if (a) the address of the first reference in the first heap equals the address of the second reference in the first heap; and (b) the object in the second heap to which the first reference points is the same as the object in the second heap to which the second reference points.

21. The method of claim 16, in which the reset facility is responsive to the detection of a cross-heap reference from the first heap to the second heap to prevent deletion of the second heap.

22. The method of claim 21, wherein the reset event output in response to the detection of the second reference further indicates that the second reference has prevented deletion of the second heap.

23. The method of claim 21, in which the reset facility is responsive to the detection of the cross-heap reference for making an attempt to eliminate cross-heap references, and deletion of the second heap is only prevented if said attempt is unsuccessful.

24. The method of claim 23, wherein said attempt potentially involves promoting one or more objects from the second heap to the first heap to eliminate cross-heap references, and said reset facility is responsive to an object promotion to output a promotion event specifying information about an object before and after it is promoted.

25. The method of claim 23, in which said reset facility outputs a reset event termed a ResetTrace event in response to the detection of said second reference prior to the attempt to eliminate cross-heap references.

26. The method of claim 23, wherein said reset facility outputs a reset event termed an Unresettable event in response to the detection of a third reference from the first heap to the second heap, said Unresettable event specifying information about said third reference.

27. The method of claim 26, wherein the information in said Unresettable event can be combined with the information in said cross-heap event to determine if said third reference matches said first reference, and with information in said ResetTrace event to determine if said third reference matches said second reference.

28. The method of claim 24, wherein the information output about an object before and after it is promoted allows the first reference to be matched to the second reference via a chain of one or more intervening promotion events.

29. The method of claim 28, wherein the first reference is matched to the second reference via a promotion event if the first reference is to a promotion object before promotion, and said second reference is from said promotion object after promotion.

30. The method of claim 16, further including the step of matching of said first and second references.

31. A computer program product comprising program instructions stored in a machine readable medium for loading into a computer system for running one or more programs and including a memory having at least a first heap and a second heap in which objects are stored, wherein a first object is stored on said first heap, said instructions causing the computer system to perform the steps of:
detecting that said first object has been updated by a program to include a first reference to a memory location in said second heaps
outputting in response to such detection a cross-heap event specifying information about said first reference and the current state of said program;
providing a facility for resetting for the second heap whereby all objects stored within the second heap are deleted;
detecting as part of the resetting a second reference from the first heap to the second heap; and
outputting in response to such detection a reset event specifying information about said second reference;
wherein the information in said reset event can be combined with the information in said cross-heap event to determine if said first reference matches said second reference.

32. The computer program product of claim 31 wherein the information in the cross-heap event about said first reference comprises the address of the first reference in the first heap, and the address of an object in the second heap to which the first reference points.

33. The computer program product of claim 31, wherein the information in the cross-heap event about the current state of the program includes a stack dump.

34. The computer program product of claim 32, wherein the information in the reset event about said second reference comprises the address of the second reference in the first heap, and the address of an object in the second heap to which the first reference points.

35. The computer program product of claim 34, in which said first reference matches said second reference if (a) the address of the first reference in the first heap equals the address of the second reference in the first heap; and (b) the object in the second heap to which the first reference points is the same as the object in the second heap to which the second reference points.

36. The computer program product of claim 31, in which the reset facility is responsive to the detection of a cross-heap reference from the first heap to the second heap to prevent deletion of the second heap.

37. The computer program product of claim 36, wherein the reset event output in response to the detection of the second reference further indicates that the second reference has prevented deletion of the second heap.

38. The computer program product of claim 36, in which the reset facility is responsive to the detection of the cross-heap reference for making an attempt to eliminate cross-heap references, and deletion of the second heap is only prevented if said attempt is unsuccessful.

39. The computer program product of claim 38, wherein said attempt potentially involves promoting one or more objects from the second heap to the first heap to eliminate cross-heap references, and said reset facility is responsive to an object promotion to output a promotion event specifying information about an object before and after it is promoted.

40. The computer program product of claim 38, in which said reset facility outputs a reset event termed a ResetTrace event in response to the detection of said second reference prior to the attempt to eliminate cross-heap references.

41. The computer program product of claim 38, wherein said reset facility outputs a reset event termed an Unresettable event in response to the detection of a third reference from the first heap to the second heap, said Unresettable event specifying information about said third reference.

42. The computer program product of claim 41, wherein the information in said Unresettable event can be combined with the information in said cross-heap event to determine if said third reference matches said first reference, and with information in said ResetTrace event to determine if said third reference matches said second reference.

43. The computer program product of claim 39, wherein the information output about an object before and after it is promoted allows the first reference to be matched to the second reference via a chain of one or more intervening promotion events.

44. The computer program product of claim 43, wherein the first reference is matched to the second reference via a promotion event if the first reference is to a promotion object before promotion, and said second reference is from said promotion object after promotion.

45. The computer program product of claim 31, further including the step of matching of said first and second references.
